(19) United States
(12) Patent Application Publication
(10) Pub. No.: US 2006/0177621 A1
(43) Pub. Date: Aug. 10, 2006

(54) O-coordinated metal chelates and their use in optical recording media having high storage capacity

(76) Inventors: Frank Bienewald, Hegenheim (FR); Jean-Luc Budry, Rossemaison (CH); Beat Schmidhalter, Bubendorf (CH); Annemarie Wolleb, Fehren (CH); Heinz Wolleb, Fehren (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/565,138

(22) PCT Filed: Jul. 12, 2004
(86) PCT No.: PCT/EP04/51447

§ 371 Date: Jan. 19, 2006

(30) Foreign Application Priority Data
Jul. 22, 2003 (EP) 0310256.9
Sep. 8, 2003 (EP) 03102718.8

(51) Int. Cl. B32B 3/02

(52) U.S. Cl. 428/64.4

(57) ABSTRACT

The invention relates to novel optical recording materials that comprise specific and in some cases novel diketone enamines or metal chelates thereof and that have excellent recording and playback quality especially at a wavelength of 350-500 nm. The invention accordingly relates to an optical recording medium comprising a substrate, a recording layer and optionally a reflecting layer, wherein the recording layer comprises a compound of formula (I), wherein M is hydrogen, aluminium or, preferably, a transition metal, which may in addition be coordinated with one or more further ligands and/or, for balancing out an excess charge, where applicable, may have an electrostatic interaction with one or more further ions inside or outside the coordination sphere, but M in formulae (Ib) and (Ic) is not hydrogen, Q is C—H, N or C—R₆, it being possible for the stereochemistry of the C=Q double bond to be either E or Z. For the exact definitions of R₁ to R₆ reference should be made to the description. Also claimed are the novel compounds, especially tetracoordinated chelates, and a process for the preparation thereof.

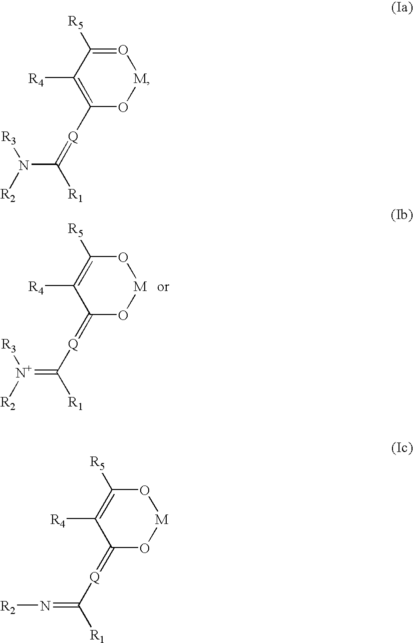

The invention relates to novel optical recording media that comprise specific and in some cases novel diketone enamines or metal chelates thereof and that have excellent recording and playback quality especially at a wavelength of 350-500 nm. Recording and playback can be effected very advantageously at the same wavelength, and the storage density that is achievable is significantly higher than in the case of known materials. In addition, the materials according to the invention have very good storage properties before and after recording, even under harsh conditions, such as exposure to sunlight or fluorescent lighting, heat and/or high humidity. In addition, their manufacture is simple and readily reproducible using customary coating processes, such as spin-coating.

U.S. Pat. No. 6,225,023 discloses optical recording media comprising N-coordinated metal chelates of heterocyclic azo compounds, for example 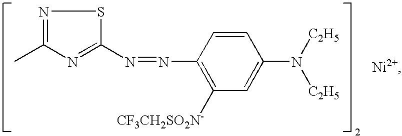
which are, however, suitable only for systems where recording and playback are effected using laser radiation of a wavelength that far exceeds 500 nm, for example 635 nm.

U.S. Pat. No. 6,242,067 discloses optical recording media comprising O-coordinated metal chelates of amino-substituted aromatic azo compounds, for example 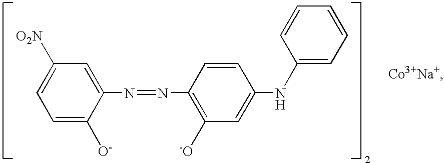
which are, however, suitable only for systems where recording and playback are effected using laser radiation of a wavelength that far exceeds 500 nm. In Example 2, recording is carried out at 635 nm and reading is carried out at 650 nm, using a numerical aperture of 0.60.

EP-A-0 597 826 discloses recording media comprising a liquid crystalline polymer (“polymer liquid crystal”) and a metal chelate or macrocyclic colorant (“large cyclic colorant”) which is soluble therein. As a result, the light absorption is increased, especially in the near infra-red, without the function of the liquid crystalline polymer being impaired. Recording and playback are effected at 830 nm.

Previous optical recording materials therefore satisfy high demands only to some extent or do not satisfy all such demands to an entirely satisfactory degree at the same time. In particular, the data density achieved (DVD±R) is not entirely satisfactory.

Polyhedron Vol. 9 No. 17, pages 2061-2069 (1990) discloses the complexing of copper(II) with 4-methyl-3-[3-dimethylaminoacryloyl]-2H-pyran-2-one. The longest-wavelength absorption band of the mixed chelate hydrates with 2,2′-bipyridine and 1,10-phenanthroline are, in the solid, 398 nm and 400 nm, respectively. Because of instability in solution it has not been possible to elucidate the influence of the complexing on the structure. It has also not been possible to prepare a 1:2 metal/chelate complex. In addition, no technical applications are mentioned.

The aim of the invention is an optical recording medium having high information density and high data reliability. Such a recording medium should be robust, durable and easy to use. Furthermore, it should be inexpensive to manufacture as a mass-produced product, it should require equipment that is as small and inexpensive as possible and it should comprise a minimum of substances of environmental concern, such as volatile toxic metals, or at least it should allow the disposal of such substances of environmental concern by simple means.

The invention accordingly relates to an optical recording medium comprising a substrate, a recording layer and optionally a reflecting layer, wherein the recording layer comprises a compound of formula 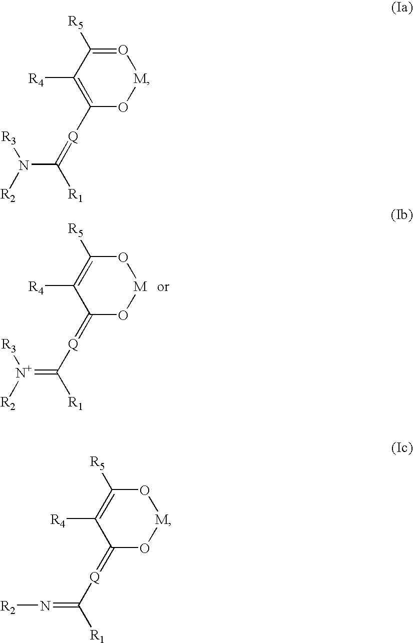
wherein
M is hydrogen, aluminium or, preferably, a transition metal, which may in addition be coordinated with one or more further ligands and/or, for balancing out an excess charge, where applicable, may have an electrostatic interaction with one or more further ions inside or outside the coordination sphere, but M In formulae (Ib) and (Ic) is not hydrogen,
Q is C—H, N or C—R₆, it being possible for the stereochemistry of the C=Q double bond to be either E or Z,
R₁ is hydrogen, OR₇, SR₇, NHR₇, NR₇R₈, C₁-C₁₂alkyl, C₂-C₁₂alkenyl, C₂-C₁₂alkynyl, C₃-C₁₂cycloalkyl, C₃-C₁₂cycloalkenyl, C₇-C₁₂aralkyl, C₂-C₁₁heteroaralkyl, C₆-C₁₀aryl or C₁-C₉heteroaryl,
R₂ and R₃ are each independently of the other C₁-C₁₂alkyl, C₂-C₁₂alkenyl, C₂-C₁₂alkynyl, C₃-C₁₂cycloalkyl, C₃-C₁₂cycloalkenyl, C₇-C₁₂aralkyl, C₂-C₁₁heteroaralkyl, C₆-C₁₀aryl or C₁-C₉heteroaryl,
R₄ is cyano, COR₉, COOR₇, CONH₂, CONHR₇, CONR₇R₈, C₂-C₁₂alk-1-enyl, C₃-C₁₂cycloalk-1-enyl, C₂-C₁₂alk-1-ynyl, C₂-C₅heterocycloalkyl, C₃-C₅heterocycloalkenyl, C₆-C₁₀aryl or C₁-C₉heteroaryl,
R₅ is cyano, COR₇, COOR₇, CONH₂, CONHR₇, CONR₇R₈, NHR₉, NRBR₉, C₁-C₁₂alkyl, C₂-C₁₂alkenyl, C₂-C₁₂alkynyl, C₃-C₁₂cycloalkyl, C₃-C₁₂cycloalkenyl, C₇-C₁₂aralkyl, C₂-C₁₁heteroaralkyl, C₆-C₁₀aryl or C₁-C₉heteroaryl,
R₆, R₇ and R₈ are each independently of the others C₁-C₁₂alkyl, C₂-C₁₂alkenyl, C₂-C₁₂alkynyl, C₃-C₁₂cycloalkyl, C₃-C₁₂cycloalkenyl, C₇-C₁₂aralkyl, C₂-C₁₁heteroaralkyl, it being possible for R₁ and R₂, R₁ and R₆, R₂ and R₃, R₂ and R₇, R₃ and R₆, R₄ and R₅, R₄ and R₆, R₄ and R₇ and/or R₇ and R₈ in pairs to be so linked to one another that 1, 2, 3 or 4 carbocyclic or N-, O- and/or S-heterocyclic rings are formed, it being possible for any such ring, independently of any other(s), where applicable to be fused to an aromatic or heteroaromatic ring and/or for a plurality of N-, O- and/or S-heterocyclic rings to be fused to one another, and
it being possible for any N in an N-heterocyclic ring to be unsubstituted or substituted by R₉; it being possible for any alkyl, alkenyl, alkynyl (in each case, where applicable, as part of non-aromatic rings), cycloalkyl or cycloalkenyl and, where applicable, a plurality of alkyl, alkenyl, alkynyl, cycloalkyl and/or cycloalkenyl groups independently of one another to be unsubstituted or mono- or poly-substituted by R₁₀; and it being possible for any aryl, heteroaryl or aralkyl or, where applicable, a plurality of aryl, heteroaryl and/or aralkyl groups independently of one another to be unsubstituted or mono- or poly-substituted by R₁₁;
R₉ being H, R₇, COR₇, COOR₇, CONH₂, CONHR₇ or CONR₇R₈;
R₁₀ being halogen, OH, NH₂, NHR₁₂, NR₁₂R₁₃, NHNH₂, NHNHR₁₂, NHNR₁₂R₁₃, NR₁₄NH₂, NR₁₄NHR₁₂, NR₁₄NR₁₂R₁₃, NHOH, NHOR₁₂, NR₁₄OH, NR₁₄OR₁₂, O—R₁₂, O—CO—R₁₂, S—R₁₂, CO—R₁₂, oxo, thiono, ═N—R₁₂, ═N—OH, ═N—O*, ═N—OR₁₂, ═N—NH₂, ═N—NHR₁₂, ═N—NR₁₂R₁₃, CN, COOH, CONH₂, COOR₁₂, CONHR₁₂, CONR₁₂R₁₃, SO₂NH₂, SO₂NHR₁₂, SO₂NR₁₂R₁₃, SO₂R₁₂, SO₃R₁₂ or PO(OR₁₂)(OR₁₃);
R₁₁ being halogen, NO₂, CN, NH₂, SH, OH, CHO, R₁₅, OR₁₅, SR₁₅, C(R₁₆)═CR₁₇R₁₈, O—CO—R₁₉, NHR₁₉, NR₁₉R₂₀, CONH₂, CONHR₁₉, CONR₁₉R₂₀, SO₂NH₂, SO₂NHR₁₉, SO₂NR₁₉R₂₀, SO₂R₁₉, COOH, COOR₁₉, OCOOR₁₉, NHCOR₁₉, NR₁₉COR₂₁, NHCOOR₁₉, NR₁₉COOR₂₁, P(═O)OR₁₉OR₂₁, P(═O)R₁₉OR₂₁, P(═O)R₁₉R₂₁, or being C₁-C₁₂alkyl, C₃-C₁₂cycloalkyl, C₂-C₁₂alkenyl, C₃-C₁₂cycloalkenyl, C₁-C₁₂alkylthio, C₃-C₁₂cycloalkylthio, C₂-C₁₂alkenylthio, C₃-C₁₂cycloalkenylthio, C₁-C₁₂alkoxy, C₃-C₁₂cycloalkoxy, C₂-C₁₂alkenyloxy or C₃-C₁₂cycloalkenyloxy each unsubstituted or substituted by one or more, where applicable identical or different, R₁₀ radicals;
R₁₂, R₁₃ and R₁₄ being each independently of the others C₁-C₁₂alkyl, C₃-C₁₂cycloalkyl, C₂-C₁₂alkenyl, C₃-C₁₂cycloalkenyl, C₆-C₁₄aryl, C₁-C₁₂heteroaryl, C₇-C₁₈aralkyl or C₂-C₁₆heteroaralkyl; or
R₁₂ and R₁₃, together with the common N, being pyrrolidine, piperidine, piperazine or morpholine each unsubstituted or mono- to tetra-substituted by C₁-C₄alkyl;
R₁₅ being C₆-C₁₄aryl, C₁-C₁₂heteroaryl, C₇-C₁₈aralkyl or C₂-C₁₆heteroaralkyl each unsubstituted or substituted by one or more, where applicable identical or different, R₂₂ radicals;
R₁₆ being hydrogen, cyano, halogen, nitro, or being C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals, or being C₆-C₁₄aryl, C₁-C₁₂heteroaryl, C₇-C₁₈aralkyl or C₂-C₁₆heteroaralkyl each unsubstituted or substituted by one or more, where applicable identical or different, R₁₀ and/or nitro radicals;
R₁₇ and R₁₈ being each independently of the other NR₁₉R₂₀, CN, CONH₂, CONHR₁₉, CONR₁₉R₂₀ or COOR₂₀;
R₁₉, R₂₀ and R₂₁ being each independently of the others R₁₅, or being C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals; or
R₁₉ and R₂₀, together with the common N, being pyrrolidine, piperidine, piperazine or morpholine each unsubstituted or mono- to tetra-substituted by C₁-C₄alkyl; or being carbazole, phenoxazine or phenothiazine each unsubstituted or substituted by one or more, where applicable identical or different, R₂₂ radicals; and
R₂₂ being halogen, NO₂, SO₂NH₂, SO₂NHR₁₂, SO₂NR₁₂R₁₃, or being C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each substituted by one or more, where applicable identical or different, R₁₀ radicals; wherein
when R₇, R₈, R₉, R₁₀, R₁₁, R₁₂, R₁₃, R₁₄, R₁₅, R₁₆, R₁₇, R₁₈, R₁₉, R₂₀, R₂₁ and/or R₂₂ are present more than once, each of them is independent of all others; and/or
two identical or different entities of formula (Ia), (Ib) or (Ic) may, if desired, have a common partial structure or be joined by a direct bond; and, when M in two such joined entities is the same, it may also be a single atom.

The joining of entities of formula (Ia), (Ib) or (Ic) accordingly results in, for example, dimers and/or telomers, which may be, for example, in the case of formula (Ia), compounds of formula

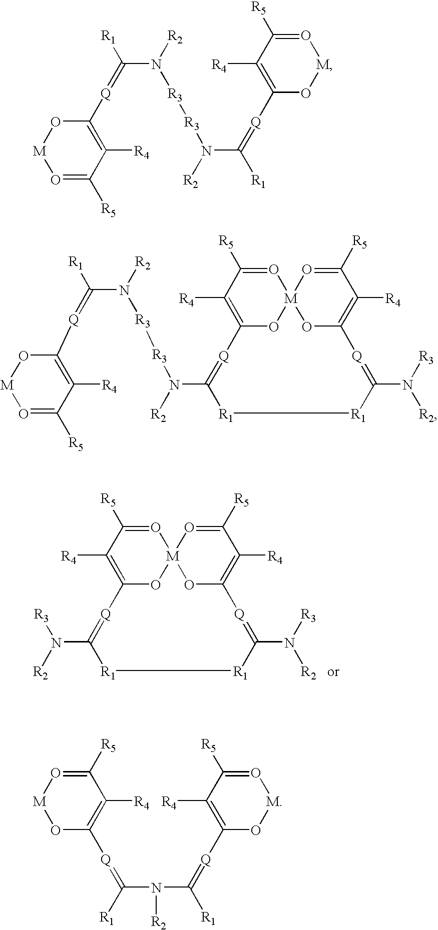

In such cases, it is, of course, possible for there to be direct bonds not only between two R₁ radicals or two R₃ radicals but also between any identical or different substituents of the partial structures and for there to be common (overlapping) partial structures other than M or NR₂R₃. In the case of different entities, a plurality of R₁, R₂, R₃, R₄, R₅ and/or Q are different from one another.

Halogen is chlorine, bromine, fluorine or iodine, preferably fluorine, chlorine or bromine, especially fluorine on alkyl (for example trifluoromethyl, β,β,β-trifluoroethyl, α,α-difluoroethyl or perfluorinated alkyl groups, such as heptafluoropropyl) and chlorine or bromine on aryl, heteroaryl or on the aryl moiety of aralkyl or on the heteroaryl moiety of heteroaralkyl.

Alkyl, cycloalkyl, alkenyl or cycloalkenyl can be straight-chain or branched, or monocyclic or polycyclic. Alkyl is, for example, methyl, straight-chain C₂-C₁₂alkyl or preferably branched C₃-C₁₂alkyl. Alkenyl is, for example, straight-chain C₂-C₁₂alkenyl or preferably branched C₃-C₁₂alkenyl. C₁-C₁₂Alkyl is therefore, for example, methyl, ethyl, n-propyl, isopropyl, n-butyl, sec-butyl, isobutyl, tert-butyl, n-pentyl, 2-pentyl, 3-pentyl, 2,2-dimethylpropyl, n-hexyl, n-octyl, 1,1,3,3-tetramethylbutyl, 2-ethylhexyl, nonyl, decyl or dodecyl. C₃-C₁₂Cycloalkyl is, for example, cyclopropyl, cyclobutyl, cyclopentyl, cyclohexyl, trimethylcyclohexyl, menthyl, thujyl, bornyl, 1 adamantyl or 2-adamantyl.

C₂-C₁₂Alkenyl or C₃-C₁₂cycloalkenyl is C₂-C₁₂alkyl or C₃-C₁₂cycloalkyl that is mono- or poly-unsaturated, wherein two or more double bonds may be isolated or conjugated, for example vinyl, allyl, 2-propen-2-yl, 2-buten-1-yl, 3-buten-1-yl, 1,3-butadien-2-yl, 2-cyclobuten-1-yl, 2-penten-1-yl, 3-penten-2-yl, 2-methyl-1-buten-3-yl, 2-methyl-3-buten-2-yl, 3-methyl-2-buten-1-yl, 1,4-pentadien-3-yl, 2-cyclopenten-1-yl, 2-cyclohexen-1-yl, 3-cyclohexen-1-yl, 2,4-cyclohexadien-1-yl, 1-p-menthen-8-yl, 4(10)-thujen-10-yl, 2-norbornen-1-yl, 2,5-norbornadien-1-yl, 7,7-dimethyl-2,4-norcaradien-3-yl or the various isomers of hexenyl, octenyl, nonenyl, decenyl or dodecenyl.

C₇-C₁₈Aralkyl is preferably C₇-C₁₂aralkyl, for example benzyl, 2-benzyl-2-propyl, β-phenyl-ethyl, 9-fluorenyl, α,α-dimethylbenzyl, δ-phenyl-butyl or β-naphthylethyl. When C₇-C₁₂aralkyl is substituted, both the alkyl moiety and the aryl moiety of the aralkyl group can be substituted, the latter alternative being preferred.

C₆-C₁₄Aryl is preferably C₆-C₁₀aryl, for example phenyl or naphthyl, especially phenyl [symbol] C₁-C₁₂Heteroaryl is an unsaturated or aromatic radical having 4n+2 conjugated n-electrons, preferably C₁-C₉heteroaryl, for example 2-thienyl, 2-furyl, 3-furazanyl, 2-pyridyl, 2-thiazolyl, 2-oxazolyl, 2-imidazolyl, Isothiazolyl, triazolyl, tetrazolyl or any other ring system consisting of thiophene, furan, pyridine, thiazole, oxazole, isoxazole, imidazole, isothiazole, triazole, pyridine and benzene rings and unsubstituted or substituted by from 1 to 6 ethyl, methyl, ethylene and/or methylene substituents, for example benzotriazolyl, and in the case of N-heterocycles where applicable also those in the form of their N-oxides.

C₂-C₁₆Heteroaralkyl is preferably C₂-C₁₁heteroaralkyl, for example C₁-C₈alkyl substituted by C₁-C₉heteroaryl.

C₂-C₅Heterocycloalkyl is, for example, an epoxide, episulfide or aziridine radical, or also oxetyl, thietyl, pyrrolidinyl, 2-pyrrolinyl, 3-pyrrolinyl, imidazoildinyl, imidazolyl, pyrazolidinyl, pyrazolyl, piperidyl, piperazinyl or morpholinyl.

Furthermore, aryl and aralkyl can also be aromatic groups linked to a metal, for example in the form of metallocenes of transition metals known per se, more especially

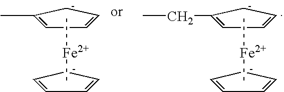

Transition metals are elements of Groups 3 to 12 (new IUPAC nomenclature). The compounds of formula (Ia), (Ib) or (Ic) are advantageously electronically neutral, which on no account precludes the presence of cations and anions, provided that their charges balance each other out. Where appropriate, they may be in the form of ion pairs and zwitterions.

M is preferably a transition metal, for example Au, Bi, Cd, Ce, Co, Cu, Cr, Hf, In, Ir, Mn, Mo, Nb, Ni, Fe, Os, Pb, Pd, Pt, Re, Rh, Ru, Si, Sn, Ta, Ti, V, W, Zn or Zr, especially Co, Cu or Ni, more especially Co(II), Cu(II) or Ni(II). Depending on the number of electrons In the outermost d shell, such transition metals are normally coordinated with from 1 to 8 ligands.

Further ligands are, for example, known compounds, e.g. ammonia, water, amines, polyamines, alcohols or polyalcohols, or also the same ligand as in formula (Ia), (Ib) or (Ic) or a ligand similar thereto, it being possible, where applicable, for two ligands to be joined by a direct bond and/or one M being coordinated to 4 oxygen atoms of 2 ligands which may be separate or joined to one another.

Q is preferably C—H or N, especially C—H.

R₉ is preferably R₇.

Carbocyclic or N-, O- and/or S-heterocyclic, non-aromatic rings have advantageously from 3 to 12 members, preferably 5 or 6 members.

When M is a transition metal, R₅ is preferably C₁-C₁₂alkyl, C₇-C₁₂alkenyl, C₂-C₁₂alkynyl, C₃-C₁₂cycloalkyl, C₃-C₁₂cycloalkenyl, C₇-C₁₂aralkyl, C₂-C₁₁heteroaralkyl, C₆-C₁₀aryl or C₁-C₉heteroaryl.

N-, O- and/or S-heterocyclic rings, where present, are preferably not themselves aromatic, although they may be fused to an aromatic or heteroaromatic ring.

When R₁ and R₆ together and/or R₄ and R₅ together form a carbocyclic or heterocyclic ring, special preference is given to the ring being neither an aromatic ring nor a pyrone. Preference is given to carbocyclic or heterocyclic rings formed by R₁ and R₆ and/or by R₄ and R₅ having at least one fully saturated carbon in the ring. Special preference is also given to carbocyclic or heterocyclic rings formed by R₁ and R₂, R₂ and R₃, R₂ and R₇, R₃ and R₆, R₄ and R₆, R₄ and R₇ and/or by R₇ and R₈ having at least one fully saturated carbon in the ring. Special preference is likewise given to R₄ and R₅ together forming a 5- or 6-membered ring.

Those preferred meanings apply both individually and in any combination. All compounds according to the invention generally exhibit more advantageous

Preference is given to chelates of formula 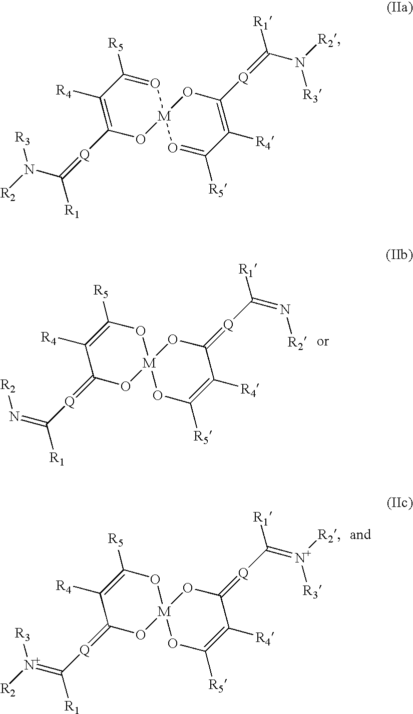
to stereoisomers, oligomers and tautomers thereof, wherein M is aluminium or a transition metal, and R₁′ independently of R₁ is as defined for R₁, R₂′ independently of R₂ is as defined for R₂, R₃′ independently of R₃ is as defined for R₃, R₄′ independently of R₄ is as defined for R₄, and R₅′ independently of R₅ is as defined for R₅, it being possible for R₁′ and R₁, for R₂′ and R₂, for R₃′ and R₃, for R₄′ and R₄, and for R₅′ and R₅ in each case to be identical or different and it being possible, where appropriate, for a radical R₁′, R₂′, R₃′, R₄′ or R₅′ to be bonded to a radical R₁, R₂, R₃, R₄ or R₅ by a direct bond.

The fact that formulae (IIa), (IIb) and (IIc) have been drawn in an idealised planar form should on no account be interpreted as limiting the stereochemical possibilities. On the contrary, the ligands may of course occupy any desired spatial arrangement in the coordination sphere around the central metal atom, for example a planar E or Z form or a tetragonal, octagonal or pyramidal form, which may also, where appropriate, be twisted.

The remarkably highly varied nature of the invention can be seen from the following purely illustrative examples, in which, for the purpose of greater clarity, further ligands have not been shown:

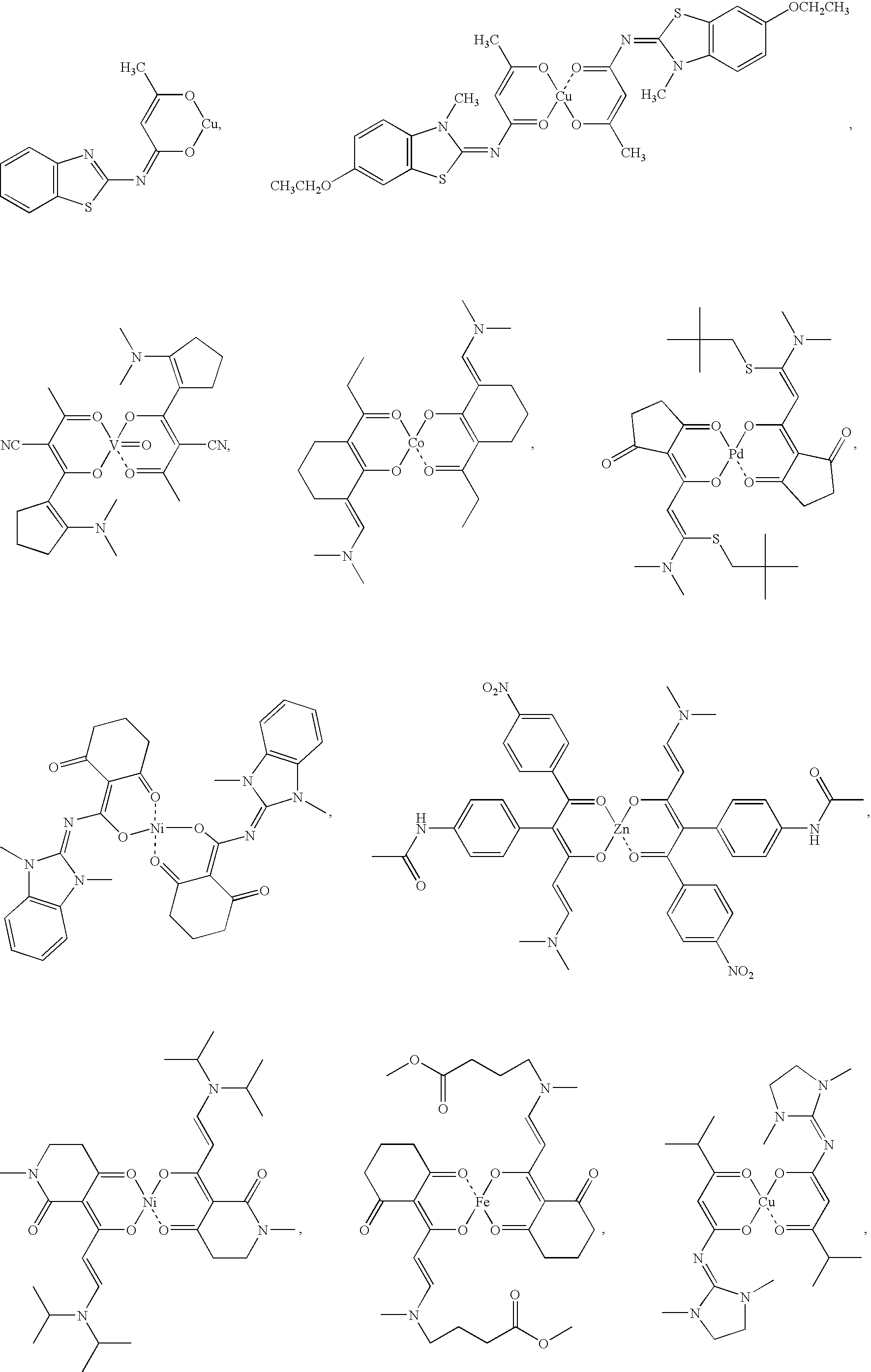

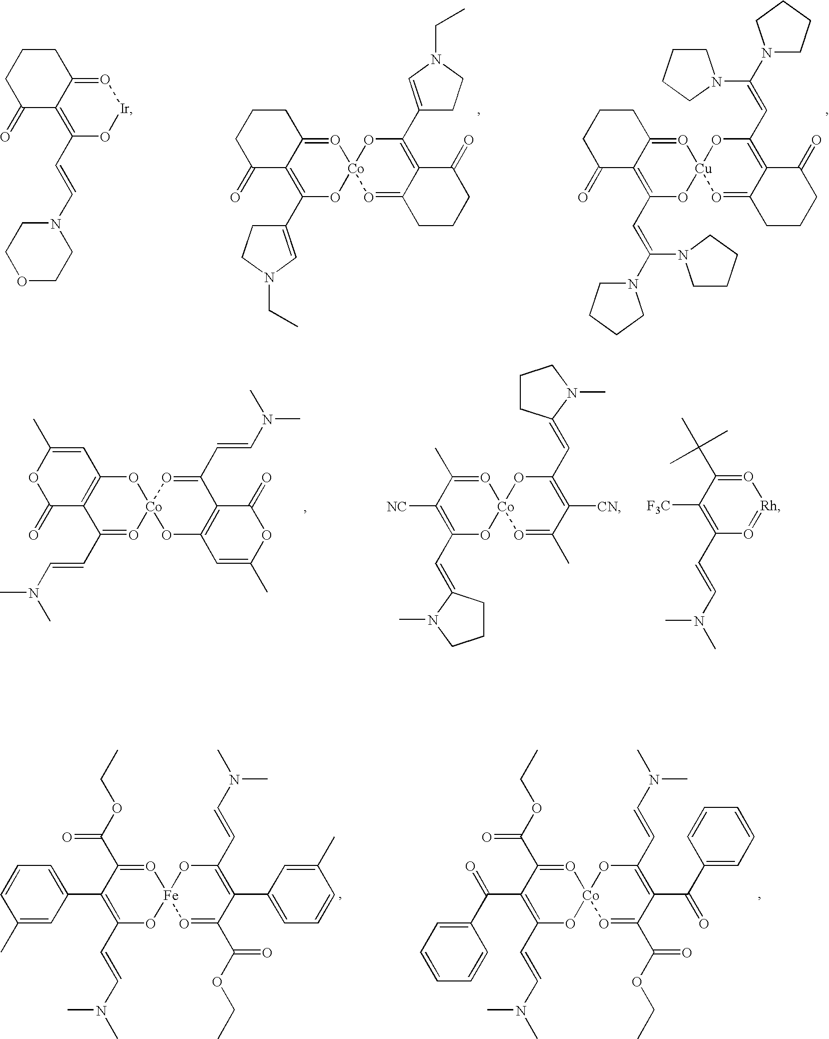

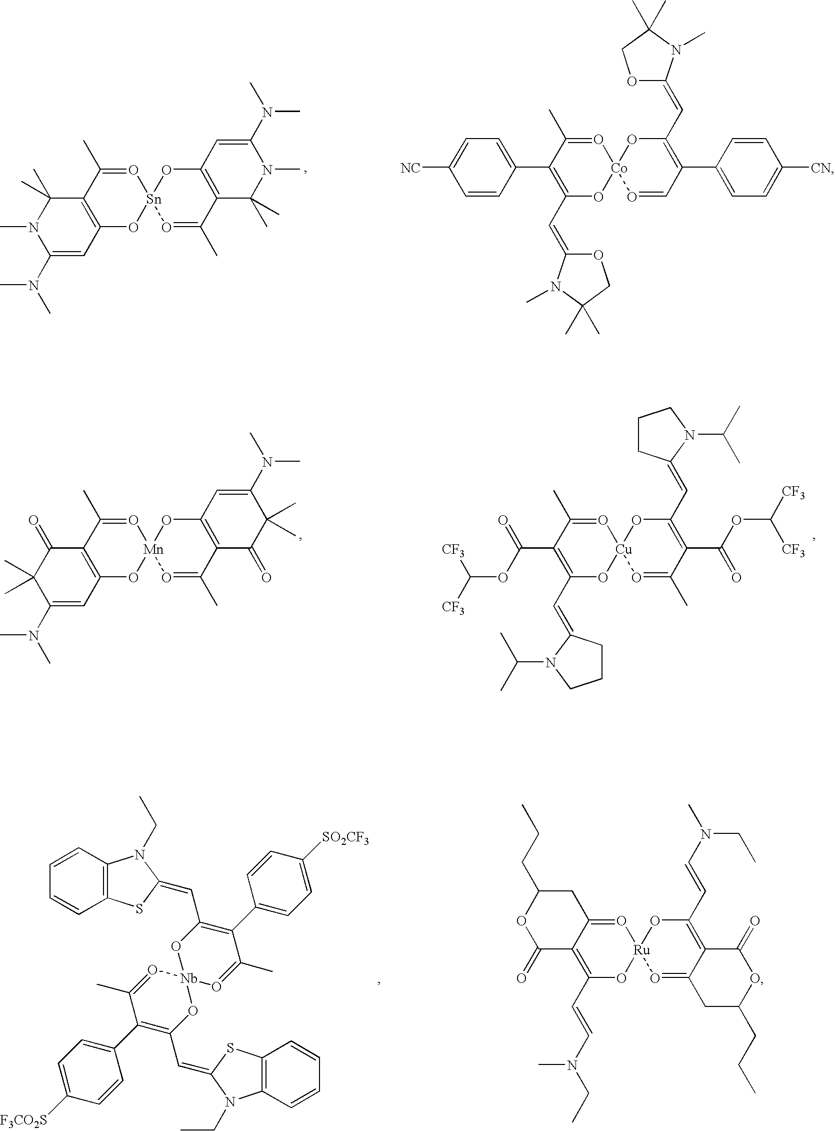

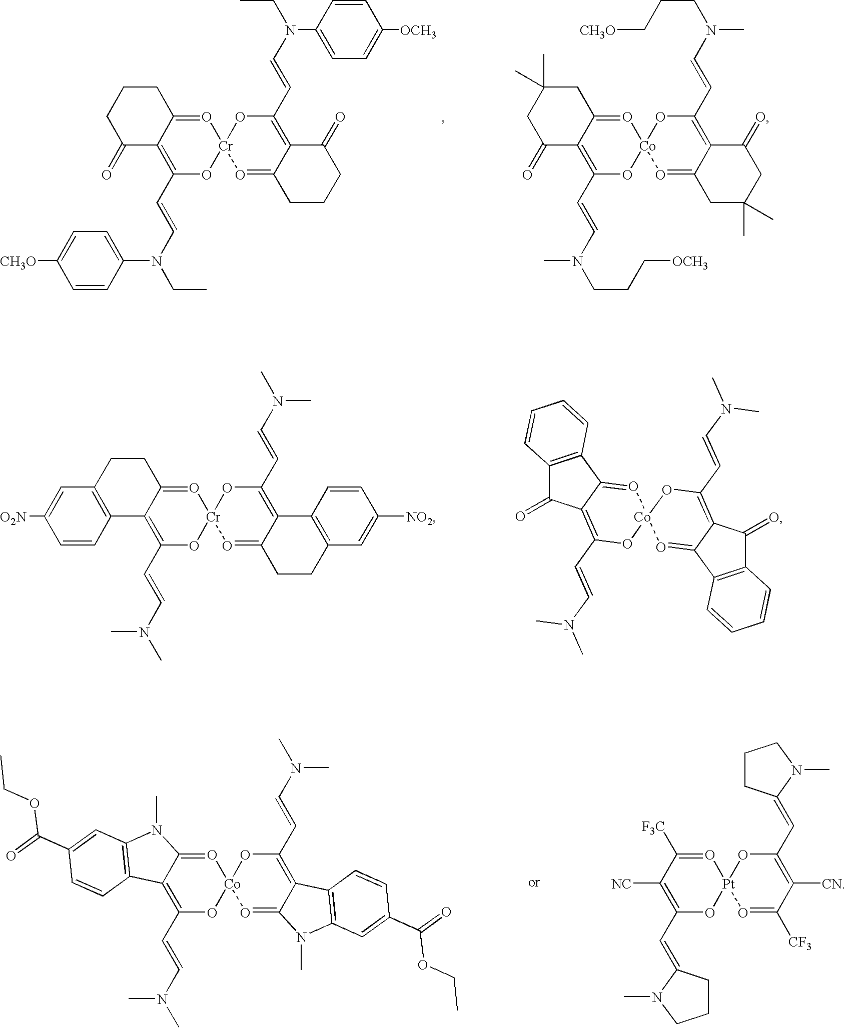

Some of the compounds of formulae (Ia), (Ib) and (Ic) are novel but they can be prepared in analogy to the known compounds using general methods known per se. The invention accordingly relates also to a compound of formula (Ia), (Ib) or (Ic) in accordance with the definitions given hereinbefore, wherein M is a transition metal, with the proviso that when R₁ and R₆ together and/or R₄ and R₅ together form a carbocyclic or heterocyclic ring, that carbocyclic or heterocyclic ring is neither an aromatic ring nor a pyrone.

The recording layer advantageously comprises a compound of formula (Ia), (Ib), (Ic), (IIa), (IIb) or (IIc) or a mixture of such compounds as main constituent or at least as an important component, for example from 1 to 100% by weight, preferably from 20 to 100% by weight, especially from 50 to 100% by weight. Further customary constituents are possible, for example other chromophores (for example those having an absorption maximum at from 300 to 1000 nm), stabilisers, ¹O₂—, triplet- or luminescence-quenchers, melting-point reducers, decomposition accelerators or any other additives that have already been described in optical recording media. Preferably, stabilisers or fluorescence-quenchers are added if desired.

Chromophores which may optionally be used in the recording layer in addition to the compounds of formula (Ia), (Ib), (Ic), (IIa), (IIb) or (IIc) are, for example, cyanines and cyanine metal complexes (U.S. Pat. No. 5,958,650), aza- and phospha-cyanines (WO 021082438), styryl compounds (U.S. Pat. No. 6,103,331), oxonol dyes (EP 0833314), azo dyes and azo metal complexes (JP 11/028,865 A), phthalocyanines (EP 0 232 427, EP 0 337 209, EP 0 373 643, EP 0 463 550, EP 0 492 508, EP 0 509 423, EP 0 511 590, EP 0 513 370, EP 0 514 799, EP 0 518 213, EP 0 519 419, EP 0 519 423, EP 0 575 816, EP 0 600 427, EP 0 676 751, EP 0 712 904, WO 98/14520, WO 00/09522, WO 02/25648, WO 02/083796, EP 1 253 586, EP 1 265 233, EP 1 271 500, CH 1137/03), porphyrins, porphyrazines (EP 0 822 546, U.S. Pat. No. 5,998,093, JP 2001/277723A, WO 03/042990), carbopyronins (WO-03/007296), dipyrromethene dyes and metal chelate compounds thereof (EP 0 822 544, EP 0 903 733), xanthene dyes and metal complex salts thereof (U.S. Pat. No. 5,851,621, WO-03/098617, WO-03/098618), pyridone metal complexes (WO-03/063151) or quadratic acid compounds (EP 0 568 877), or oxazines, dioxazines, diazastyryls, formazans, anthraquinones or phenothiazines; this list is on no account exhaustive and the person skilled in the art will interpret the list as including further known dyes, for example those of PCT/EP2004/050185 or PCT/EP2004/050206.

Mixtures have, as is known, a number of advantages, for example better solubility and a lower tendency towards crystallisation, so that it is easier to produce stably amorphous layers by spin-coating. By optimisation of the mixing ratios in a manner and optical properties, especially having steep absorption bands. In addition, It Is often thus possible to counteract the flattening of the spectral absorption edge in the solid state. Optimum mixing ratios are therefore generally determined by series of tests, in which different groove geometries are also included.

It will be understood that, where applicable, preference is given to those additional dyes which are themselves known for use in optical recording materials at from 300 to 500 nm. Special preference is given to mixtures of the compounds of formula (Ia), (Ib), (Ic), (IIa), (IIb) or (IIc), for example mixtures of isomers. Mixtures of compounds of formula (Ia), (Ib), (Ic), (IIa), (IIb) or (IIc) wherein M is a transition metal with compounds of formula (Ia) wherein M is hydrogen are also especially advantageous.

When the recording layer comprises other chromophores that are not suitable per se for use at from 300 to 500 nm, the amount of such chromophores should preferably be small, so that the absorption thereof at the wavelength of the inflection point (point of maximum gradient) of the gradient of the long-wavelength flank of the absorption band of the entire solid layer, which is a decisive factor for the recording, is a fraction of the absorption of the compounds of formula (Ia), (Ib), (Ic), (IIa), (IIb) or (IIc) in the entire solid layer at the same wavelength, advantageously at most ⅓, preferably at most ⅕, especially at most 1/10. The absorption maximum of dye mixtures in the spectral range from 300 to 500 nm is preferably at a wavelength lower than 450 nm, preferably lower than 400 nm, especially at 340-380 nm.

Stabilisers and ¹O₂—, triplet- or luminescence-quenchers are, for example, metal complexes of N- or S-containing enolates, phenolates, bisphenolates, thiolates or bisthiolates or of azo, azomethine or formazan dyes, such as bis(4-dimethylamino-dithiobenzil)nickel [CAS NO 38465-55-3], ®Irgalan Bordeaux EL, ®Cibafast N or similar compounds, hindered phenols and derivatives thereof, such as ®Cibafast AO, o-hydroxyphenyl-triazoles or -triazines or other UV absorbers, such as ®Cibafast W or ®Cibafast P or hindered amines (TEMPO or HALS, also as nitroxides or NOR-HALS), also diimmonium, Paraquat™ or Orthoquat™ salts, such as ®Kayasorb IRG 022, ®Kayasorb IRG 040, or optionally also radical salts, such as N,N,N′,N′-tetrakis(4-Organica (Wolfen/DE); ®Kayasorb brands are available from Nippon Kayaku Co. Ltd., and ®Irgalan and ®Cibafast brands are available from Ciba Spezialitätenchemle AG.

Many such structures are known, some of them also in connection with optical recording media, for example from U.S. Pat. No. 5,219,707, JP 06/199045 A, JP 07/76169 A, JP 07/262,604 A or JP 2000/272241 A. They may be, for example, salts of metal complex anions, as disclosed in the above-mentioned publications, or metal complexes, illustrated, for example, by a compound of formula

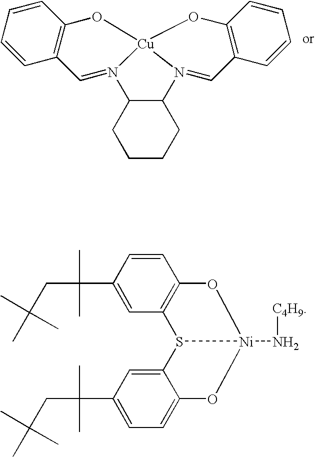

The person skilled in the art will know from other optical information media, or will easily identify, which additives in which concentration are particularly well suited to which purpose. Suitable concentrations of additives are, for example, from 0.001 to 1000% by weight, preferably from 1 to 50% by weight, based on the recording medium of formula (Ia), (Ib), (Ic), (IIa), (IIb) or (IIc).

The optical recording materials according to the invention exhibit, overall, excellent spectral properties of the solid amorphous recording layer, the refractive index also being surprisingly high. By virtue of an aggregation tendency in the solid that is surprisingly low for such compounds, the absorption band is narrow and intense, the absorption band being especially steep on the long-wavelength side. Crystallites are unexpectedly and very advantageously not formed or are formed only to a negligible extent. The reflectivity of the layers in the range of the writing and reading wavelength is high in the unwritten state. The sensitivity towards laser radiation is high in writing mode; in the lower energy reading mode, the stability with respect thereto is high.

By virtue of those excellent layer properties it is possible to obtain a rapid optical mark boundaries, the refractive Index and the reflectivity changing substantially, which gives a high degree of contrast. The differences In the mark lengths and the Interval distances (“jitter”) are surprisingly small both at normal recording speed (about from 4.5 to 5.5 m·s⁻¹) and at a higher recording speed (for example from 9 m·s⁻¹ to 25 m·s⁻¹ or even higher), which enables a high storage density to be obtained using a narrow recording channel with a relatively small track spacing (“pitch”). In addition, the recorded data are played back with an astonishingly low error rate, so that relatively short marks are possible, including, for example, those of length 0.15±0.01 μm (2T) in conformity with the Blu-Ray™ standard, and error correction requires only a small amount of storage space.

By virtue of the excellent solubility, including in apolar solvents, solutions can be used even in high concentrations without troublesome precipitation, for example during storage, so that problems during spin-coating are largely eliminated. This applies especially to compounds containing branched C₃-C₈alkyl.

Recording and playback can take place at the same wavelength with a laser source of advantageously from 300 to 500 nm, especially from 350 to 500 nm, preferably from 370 to 450 nm. Especially preferred is the UV range from 370 to 390 nm, especially approximately 380 nm, or especially at the edge of the visible range of from 390 to 430 nm, more especially approximately 405±5 nm. In the field of compact, blue or violet laser diodes (such as Nichia GaN 405 nm) with an optical system of high numerical aperture (for example 0.85) the marks can be so small and the tracks so narrow that up to about 20 to 30 Gb per recording layer is achievable on a 120 mm disc. At 380 nm it is possible to use indium-doped UV-VCSELs (Vertical-Cavity Surface-Emitting Laser), which laser source already exists as a prototype [Jung Han et al., see MRS Internet J. Nitride Semicond. Res. 5S1, W6.2 (2000)].

The invention therefore relates also to a method of recording or playing back data, wherein the data on an optical recording medium according to the invention are recorded or played back at a wavelength of from 300 to 500 nm. The recording preferably takes place at a linear speed ν of at least 4.5 m·s⁻¹, there especially being longest of which are of a length corresponding to approximately four times the width. The linear speed is especially at least 9 m·s⁻¹ (1×), 18 m·s⁻¹ (2×) or 36 m·s⁻¹ (4×).

The recording medium can be based on the structure of known recording media and in that case is, for example, analogous to those mentioned above, such as DVD+R or DVD-R. It may therefore be composed, for example, of a transparent substrate, a recording layer comprising at least one of the compounds of formula (Ia), (Ib), (Ic), (IIa), (IIb) or (IIc), a reflector layer and a covering layer, the writing and readout being effected through the substrate. Such a system suitable for recording and playback at a wavelength of from 300 to 500 nm is, for example, HD-DVD™ (formerly known as advanced optical disk AOD).

Suitable substrates are, for example, glass, minerals, ceramics and thermosetting and thermoplastic plastics. Preferred supports are glass and homo- or co-polymeric plastics. Suitable plastics are, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. Special preference is given to polycarbonate substrates which can be produced, for example, by injection-moulding. The substrate can be in pure form or may comprise customary additives, for example UV absorbers or dyes, as proposed e.g. in JP 04/167239 A as light stabilisation for the recording layer. In the latter case it may be advantageous for the dye added to the support substrate to have no or at most only low absorption in the region of the writing wavelength (emission wavelength of the laser), preferably up to a maximum of about 20% of the laser light focussed onto the recording layer.

The substrate is advantageously transparent over at least a portion of the range from 300 to 500 nm, so that it is permeable to, for example, at least 80% of the incident light of the writing or readout wavelength. The substrate is advantageously from 10 μm to 2 mm thick, preferably from 100 to 1200 μm thick, especially from 600 to 1100 μm thick, with a preferably spiral guide groove (track) on the coating side, a groove depth of from 10 to 200 nm, preferably from 50 to 150 nm, a groove width of two grooves of from 200 to 600 nm, preferably from 250 to 450 nm (for example with a groove depth of 100±20 nm, a groove width of 200±50 nm and an axial spacing between two turns of 370±60 nm). Grooves of different cross-sectional shape are known, for example rectangular, trapezoidal or V-shaped. Analogously to the known CD-R and DVD±R media, the guide groove may additionally undergo a small periodic or quasi-periodic lateral deflection (wobble), so that synchronisation of the speed of rotation and the absolute positioning of the readout head (pick-up) is made possible. Instead of, or in addition to, the deflection, the same function can be performed by markings between adjacent grooves (pre-pits).

The recording medium is applied, for example, by application of a solution by spin-coating, the objective being to produce a layer that is as amorphous as possible, the thickness of which, layer is advantageously from 0 to 70 nm, preferably from 1 to 20 nm, especially from 2 to 10 nm, on the surface (“land”) and, depending upon the geometry of the groove, advantageously from 20 to 150 nm, preferably from 30 to 120 nm, especially from 30 to 80 nm, in the groove. In another embodiment, achievable by means of the compounds of formula (Ia), (Ib) or (Ic), the thickness of the recording layer may advantageously be from 30 to 80 nm in the groove and from 20 to 70 nm alongside (“land”), the difference between the layer thicknesses in the groove and on the surface being less than 20 nm, preferably less than 10 nm. As a result it is possible, compatibly with HD-DVD-RW, to write and read both in the grooves and on the surface alongside. The track pitch is in that case only about half as great, and the total storage capacity is greater.

In both embodiments, writing and readout take place from the substrate side. The laser beam is directed onto the recording layer through the substrate and has a wavelength of preferably from 300 to 500 nm, especially from 370 to 450 nm. A reflector layer may be present on the side of the recording layer opposite from the substrate.

Reflecting materials suitable for the reflector layer include especially metals, which provide good reflection of the laser radiation used for recording and playback, for Periodic Table of the Elements. Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt and the lanthanide metals Ce, Pr, Nd, Pm, Sm, Eu, Gd, Tb, Dy, Ho, Er, Tm, Yb and Lu, and alloys thereof, are especially suitable. On account of its high reflectivity and ease of production special preference Is given to a reflective layer of aluminium, silver, gold or an alloy thereof (for example a white gold or silver/chromium alloy), especially aluminium on economic and ecological grounds. The reflector layer is advantageously from 5 to 200 nm thick, preferably from 10 to 100 nm thick, especially from 20 to 80 nm thick, but reflector layers of greater thickness are also possible.

Materials suitable for the covering layer include chiefly plastics, which are applied in a thin layer to the reflector layer either directly or with the aid of adhesion promoters. It is advantageous to select mechanically and thermally stable plastics having good surface properties, which can be modified further, for example written on. The plastics may be thermosetting plastics and thermoplastic plastics. Directly applied covering layers are preferably radiation-cured (e.g. using UV radiation) coatings, which are particularly simple and economical to produce. A wide variety of radiation-curable materials are known. Examples of radiation-curable monomers and oligomers are acrylates and methacrylates of diols, triols and tetrols, polyimides of aromatic tetracarboxylic acids and aromatic diamines having C₁-C₄alkyl groups in at least two ortho-positions of the amino groups, and oligomers with dialkylmaleinimidyl groups, e.g. dimethylmaleinimidyl groups. For covering layers that are applied using adhesion promoters it is preferable to use the same materials as those used for the substrate layer, especially polycarbonates. The adhesion promoters used are preferably likewise radiation-curable monomers and oligomers. Instead of the covering layer applied using an adhesion promoter there may also be used a second substrate comprising a recording and reflector layer, so that the recording medium is playable on both sides. Preference is given to a symmetrical structure, the two parts being joined together at the reflector side by an adhesion promoter directly or by way of an intermediate layer. In that case, it will be understood that the substrate is only about half as thick so that the whole disc composed of two substrates is of about the same thickness as a disc consisting of only one substrate.

In such a structure, the optical properties of the covering layer, or the covering materials, are essentially unimportant per se provided that, where applicable, curing thereof e.g. by UV radiation is achieved. The function of the covering layer is to ensure the mechanical strength of the recording medium as a whole and, if necessary, the mechanical strength of thin reflector layers. If the recording medium is sufficiently robust, for example when a thick reflector layer is present, it is even possible to dispense with the covering layer altogether. The thickness of the covering layer depends upon the thickness of the recording medium as a whole, which should preferably be a maximum of about 2 mm thick. The covering layer is preferably from 10 μm to 1 mm thick.

The recording media according to the invention may also have additional layers, for example interference layers or barrier layers. It is also possible to construct recording media having a plurality of (for example from two to ten) recording layers. The structure and the use of such materials are known to the person skilled in the art. Where present, interference layers are preferably arranged between the recording layer and the reflecting layer and/or between the recording layer and the substrate and consist of a dielectric material, for example, as described in EP 0 353 393, of TiO₂, Si₃N₄, ZnS or silicone resins.

The recording media according to the invention can be produced by processes known per se, ft being possible for various methods of coating to be employed depending upon the materials used and their function.

Suitable coating methods are, for example, immersion, pouring, brush-coating, blade-application and spin-coating, as well as vapour-deposition methods carried out under a high vacuum. When, for example, pouring methods are used, solutions in organic solvents are generally employed. When solvents are employed, care should be taken that the supports used are insensitive to those solvents. Suitable coating methods and solvents are described, for example, in EP 0 401 791 or EP 0 485 337.

The recording layer is applied preferably by the application of a dye solution by spin- [symbol] 2-methoxyethanol, 1-methoxy-2-propanol, 2-propanol or n-butanol, hydroxyketones, for example diacetone alcohol or 3-hydroxy-3-methyl-2-butanone, hydroxy esters, for example lactic acid methyl ester or Isobutyric acid methyl ester, or preferably fluorinated alcohols, for example 2,2,2-trifluoroethanol or 2,2,3,3-tetrafluoro-1-propanol, and mixtures thereof. Further suitable solvents are disclosed, for example, in EP 0 483 387.

The application of the metallic reflector layer is preferably effected by sputtering or by vapour-deposition in vacuo. Such techniques are known and are described in specialist literature (e.g. J. L. Vossen and W. Kem, “Thin Film Processes”, Academic Press, 1978). The operation can advantageously be carried out continuously and achieves good reflectivity and a high degree of adhesiveness of the metallic reflector layer.

Recording is carried out in accordance with known methods by writing pits (marks) of fixed or, usually, variable length by means of a modulated, focussed laser beam guided at a constant or variable speed over the surface of the recording layer. Readout of information is carried out according to methods known per se by registering the change in reflection using laser radiation, for example as described in “CD-Player und R-DAT Recorder” (Claus Biaesch-Wiepke, Vogel Buchverlag, Würzburg 1992). The person skilled in the art will be familiar with the requirements.

The information-containing medium according to the invention is especially an optical information material of the WORM type. It can be used, for example, analogously to CD-R (compact disc-recordable) or DVD*R (digital video disc-recordable) in computers, and also as storage material for identification and security cards or for the production of diffractive optical elements, for example holograms. Recording media of the HD-DVD type allow the use of a laser having a numerical aperture of a maximum of about 0.7 (usually from 0.60 to 0.65), in which case at a recording speed of 6.61 m·s⁻¹ (or a multiple thereof), discs of 120 mm diameter will have a storage capacity of 15 GB per recording layer.

Alternatively, however, there are also recording media which differ substantially from CD-R and DVD±R and in which recording and playback take place not through the substrate but through the covering layer. Accordingly the respective roles of the covering layer and the substrate, especially the geometry and the optical properties, are reversed in comparison with the structure described before. Analogous concepts for digital video recordings in conjunction with a blue GaN laser diode are known, for example from Proceedings SPIE-Int. Soc. Opt. Eng. 1999, 3864. Also at an advanced stage of development is Blu-ray™ (formerly Blu-ray Disk “BD”) with a recording speed of 5.0±0.3 m·s⁻¹ (presumably soon a multiple thereof) and a storage capacity of 25±2 GB (see system description for “Blu-ray Disc Rewritable Format version 1.0”, June 2002 and also http://www.Blu-ray.com). For such recording media, which are especially suitable for a high storage density and have correspondingly small marks (“pits”), precise focussing is important, so that the manufacturing process, while essentially analogous, is considerably more awkward.

The compounds of formula (Ia), (Ib), (Ic), (IIa), (IIb) or (IIc) according to the invention, however, also meet the increased demands of an inverse layer structure surprisingly well. Preference is therefore given to an inverse layer structure having the layer sequence substrate, reflector layer, recording layer and covering layer. The recording layer is therefore located between the reflector layer and the covering layer. A thin covering layer approximately from 50 to 400 μm in thickness is especially advantageous (typically 100 μm at a numerical aperture of 0.85).

Recording and reflector layers in an inverse layer structure have in principle the same functions as indicated above. The substrate usually has dimensions within the ranges indicated above. The preferably spiral guide groove (track) on the coating side advantageously has a groove depth of from 10 to 100 nm, preferably from 20 to 80 nm. The cross-sectional shape, periodic or quasi-periodic lateral deflection (wobble) as well as any additional markings between adjacent grooves (pre-pits) will be based on the HD-DVD type described above.

The reflector layer and the recording layer are applied to the substrate in that order. track, reference usually being made to “in-groove” media in the first case and to “on-groove” media in the second case. Using the compounds of formula (I) it is advantageously possible to achieve both forms, possibly also simultaneously.

The recording medium is applied, for example, as indicated above, it being especially advantageous that it is possible also to select solvents that would attack the substrate material, for example chlorinated or aromatic hydrocarbons. The thickness of the layer, which is as amorphous as possible, can be uniform or it can be different in the grooves and on the raised portions. In the grooves the thickness of the recording layer is advantageously from 20 to 200 nm, preferably from 30 to 150 nm, especially from 30 to 100 nm. When the track on the raised portions is to be used for recording, its layer thickness is advantageously from 10 to 120 nm, preferably from 20 to 100 nm, especially from 20 to 60 nm, whereas when only the groove is used as the track, a layer thickness of from 0 to 100 nm, preferably from 0 to 60 nm, especially from 0 to 20 nm, is sufficient. In both cases the track width (raised portions and/or indentations) is from 100 to 300 nm, preferably from 120 to 250 nm, especially from 150 to 200 nm, and the axial spacing between two tracks is from 200 to 600 nm, preferably from 250 to 400 nm, especially from 300 to 340 nm. Good results are obtained, for example, with a raised track (“on-groove”) 30±10 nm deep and 180±10 nm wide with an axial spacing of 320±10 nm. In that case the laser beam, with a high aperture, passes through the covering layer, which increases the resolution.

The inverse layer structure, however, requires substantially higher standards, which the compounds used according to the invention fulfil astonishingly well. Particularly high standards are required, for example, when the recording layer is applied to the metallic reflector layer and especially when a covering layer is applied to the recording layer, the covering layer being required to provide the recording layer with adequate protection against rubbing, photo-oxidation, fingermarks, moisture and other environmental effects and advantageously having a thickness in the range of from 0.01 to 0.5 mm, preferably in the range of from 0.05 to 0.2 mm, especially in the range of from 0.08 to 0.13 mm.

The covering layer preferably consists of a material that exhibits a transmission of 80% or above at the writing or readout wavelength of the laser. Suitable materials for the covering layer include, for example, those materials mentioned above, but especially polycarbonate (such as Pure Ace® or Panlite®, Teijin Ltd), cellulose triacetate (such as Fujitac®, Fuji Photo Film) or polyethylene terephthalate (such as Lumirror®, Toray Industry), special preference being given to polycarbonate. Especially in the case of directly applied covering layers, radiation-cured coatings, such as those already described above, are advantageous, for example SD 347™ (Dainippon Ink).

The covering layer can be applied directly to the solid recording layer by means of a suitable adhesion promoter. In another embodiment, there is applied to the solid recording layer an additional, thin separating layer of a metallic, crosslinked organometallic or preferably dielectric inorganic material, for example in a thickness of from 0.001 to 10 μm, preferably from 0.005 to 1 μm, especially from 0.01 to 0.1 μm, for example from 0.05 to 0.08 μm in the case of dielectric separating layers and from 0.01 to 0.03 μm in the case of metallic separating layers. Separating layers and corresponding methods are disclosed in WO 02/082438, to which reference is expressly made here. If desired, such coatings can be applied, for example, in the same thickness also between the support material and the metallic reflector layer or between the metallic reflector layer and the optical recording layer. This may be advantageous in certain cases, for example when a silver reflector is used in combination with sulfur-containing additives in the recording layer.

Analogously to the structure described hereinbefore, it is of course also possible in this case for these recording media to be joined together from two halves, in which case two substrates are bonded before or after coating. It is also, in addition, possible to use a substrate which is provided with grooves on both sides. In the case of a recording medium having an inverse layer structure, the transparency of the substrate is, on the other hand, immaterial. It is also possible to use, for example, coloured (e.g. yellow-, orange-, red-, blue-, green-, brown-, white-, grey- or black-pigmented) plastics or also other synthetic or natural materials such as steel, aluminium or other metals, or also paper (see Proceedings of SPIE Vol. 5380104 “A 25 GB paper disk”).

Some of the compounds used according to the invention are known, for example from Polyhedron Vol. 9 No. 17, pages 2061-2069 (1990).

It is also possible, however, to prepare analogously to the known compounds novel compounds that can be used in accordance with the invention in optical recording media.

The compounds of formulae (IIa), (IIb) and (IIc) are novel. The invention accordingly relates also to a compound of formula (IIa), (IIb) or (IIc) as defined hereinbefore.

The invention additionally relates to a process for the preparation of a chelate of formula (IIa), (IIb) or (IIc) wherein M is aluminium or a transition metal, which comprises
(a) deprotonating a compound of formula (Ia), (Ib), (Ic) or (IIa), wherein M is hydrogen, in a hydrophilic, O-containing liquid using a base;
(b) adding a non-inert salt of aluminium or a transition metal M;
(c) optionally adding additional ligands in a from 1.0× to 1.5× stoichiometric amount;
(d) optionally adding another liquid which is miscible with the O-containing liquid so that the chelate of formula (IIa), (IIb) or (IIc) precipitates out; and
(e) isolating the chelate of formula (IIa), (IIb) or (IIc).

Hydrophilic, O-containing liquids are, for example, water, alcohols, ethers, amides or mixtures thereof, including polyols and polyethers, especially organic liquids containing from 1 to 6 carbon atoms. By way of example there may be mentioned methanol, ethanol, n-propanol, isopropanol, n-butanol, isobutanol, 2-butanol, tert-butanol, diethyl ether, tetrahydrofuran, formamide, dimethylformamide and N-methyl-2-pyrrolidone.

The base must advantageously be of sufficiently high basicity to bring about the desired deprotonation. There may be used, for example, alkali metal or alkaline earth metal hydroxides, alcoholates, carbonates or hydrides. Non-inert salts are those having sufficient solubility in the liquid to be able to form the desired chelates. Preference is given to salts of organic or, especially, inorganic acids, such as citrates, oxalates, halides, nitrates or sulfates.

Additional ligands, where applicable, are advantageously present in a from 1.0× to 1.2× stoichiometric amount and preferably are not added before step (c). The stoichiometric amount corresponds to the desired number of such ligands in the chelate of formula (IIa), (IIb) or (IIc).

Further liquids which promote or accelerate the precipitation of the desired product are, for example, water or apolar hydrocarbons. Depending on the reaction liquid and polarity of the desired product, they can be selected on the basis of customary criteria known per se.

Isolation of the chelates is usually carried out by filtration or by extraction from an aqueous phase (where appropriate after adding water) using a water-immiscible solvent. Isolating substances by extraction with shaking, including all subsequent steps, is well known per se. It is, however, also possible to use any alternative method, for example flash chromatography.

Some of the compounds of formulae (Ia), (Ib) and (Ic) are known; others are novel but can be prepared analogously to the known compounds. The invention relates also to the novel compounds of formulae (Ia), (Ib) and (Ic).

The Examples that follow illustrate the invention but do not limit the scope thereof (unless otherwise indicated, “%” always refers to % by weight):

### EXAMPLE 1

5.68 g of 2-acetyl-1,3-cyclohexanedione are introduced into 85 ml of tetrahydrofuran (THF) in a 100 ml multi-necked flask equipped with a magnetic stirrer, thermometer and nitrogen transfer line and then 5.27 g of N,N-dimethylformamide solvent Is then distilled off at 60° C./2.5·10³ Pa. 7.77 g of a red-brown solid are obtained, which is dissolved in 17 ml of ethanol under reflux. The solution is slowly cooled to 0° C., with stirring. The crystallised product is filtered off, washed with 15 ml of ice-cold ethanol in portions and dried at 40° C./2.5·10³ Pa for 18 hours. There are obtained 4.60 g (59.7% of theory) of slightly yellow crystals of 2-(3-dimethylamino-acryloyl)-cyclohexane-1,3-dione: 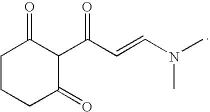
UV/VIS (NMP=N-methyl-2-pyrrolidone): λₘₐₓ=377 nm, ε=51900 l·mol⁻¹·cm⁻¹.

### EXAMPLE 2

2.94 g of 2-(3-dimethylamino-acryloylycyclohexane-1,3-dione according to Example 1 are suspended in 20 ml of ethanol and stirred at 23° C. with 7 ml of 2N sodium hydroxide solution for 15 minutes. A solution of 940 mg of anhydrous copper(II) chloride in 7 ml of ethanol is added and stirring is continued at 23° C. for a further 18 hours. The product that precipitates out is filtered off, washed twice using 7 ml of water each time and twice using 7 ml of ethanol each time and then dried at 20° C./20 Pa. There are obtained 3.21 g of bis(2-(3-dimethylamino-acryloyl)-cyclohexane-1,3-dionato)copper(II) in the form of a yellow-brown powder:

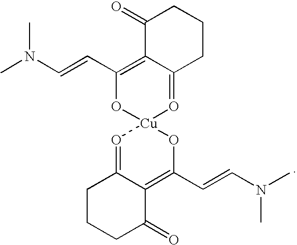

UV/VIS (ethanol): λₘₐₓ=363; ε=69540 l·mol⁻¹·cm⁻¹.

### EXAMPLE 3

211 mg of 2-(3-dimethylamino-acryloyl)-cyclohexane-1,3-dione according to Example 1 are suspended in 5 ml of ethanol and stirred at 23° C. with 1 ml of 1N sodium hydroxide solution for 15 minutes. A solution of 118 mg of cobalt(II) chloride hexahydrate In 1 ml of ethanol is added and stirring is continued at 23° C. for a further 18 hours. The solvent is removed at 40° C./2.5·10³ Pa and the residue is taken up in 8 ml of dichloromethane; the mixture is dried over sodium sulfate and filtered and the solvent is again removed at 40° C./2.5·10³ Pa. There are obtained 215 mg of bis(2-(3-dimethylamino-acryloyl)-cyclohexane-1,3-dionato)cobalt(II) in the form of a green-brown powder:

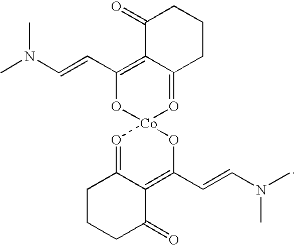

UV/VIS (ethanol): λₘₐₓ=375; ε=90000 l·mol⁻¹·cm⁻¹.

### EXAMPLE 4

418 mg of 2-(3-dimethylamino-acryloyl)-cyclohexane-1,3-dione according to Example 1 are suspended in 6 ml of ethanol and stirred at 23° C. with 108 mg of sodium methanolate for 15 minutes. A solution of 129 mg of anhydrous nickel(II) chloride in 1 ml of water is added and stirring is continued at 23° C. for a further 18 hours. The solvent is removed at 40° C./2.5·10³ Pa. There are obtained 560 mg of yellow-green solid bis(2-(3-dimethylamino-acryloyl)-cyclohexane-1,3-dionato)nickel(II), mixed with a small amount of sodium chloride:

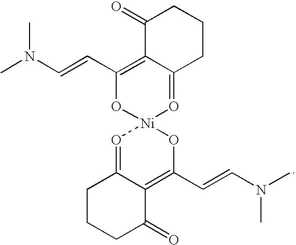

UV/VIS (ethanol): λₘₐₓ=372; ε=45370 l·mol⁻¹·cm⁻¹.

### EXAMPLE 5

4.33 g of 1,3,3-trimethyl-2-methylene-Indoline are introduced into a 25 ml glass vessel equipped with a magnetic stirrer and nitrogen transfer line and 2.10 g of diketene are added. The dark-violet solution Is stirred at an internal temperature of 100° C. for 1½ hours and the reaction mixture is then cooled to 23° C. The dark-violet solid is heated to reflux in 22 ml of heptane. The solution is decanted off from the undissolved material, is again heated to reflux and then slowly cooled to 0° C. The crystallised product is filtered off, washed with 10 ml of ice-cold heptane in portions and dried at 50° C./2.5·10³ Pa for 18 hours. There are obtained 3.32 g of orange crystals of 1-(1,3,3-trimethyl-1,3-dihydro-indol-2-ylidene)pentane-2,4-dione:

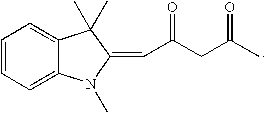

UV/VIS (NMP): λₘₐₓ=395 nm, ε=34060 l·mol⁻¹·cm⁻¹.

### EXAMPLE 6

257 mg of 1-(1,3,3-trimethyl-1,3-dihydro-indol-2-ylidene)-pentane-2,4-dione according to Example 5 are suspended in 2 ml of methanol and stirred at 23° C. with 54 mg of sodium methanolate for 15 minutes. A solution of 117 mg of cobalt(II) chloride hexahydrate in 1 ml of methanol is added and stirring is continued at room temperature for a further 3 hours. The product that precipitates out is filtered off, washed twice using 1 ml of methanol each time and then dried at 20° C./20 Pa. There are obtained 266 mg of bis(1-(1,3,3-trimethyl-1,3-dihydro-indol-2-ylidene)-pentane-2,4-dionato)cobalt(II) in the form of an orange-brown powder:

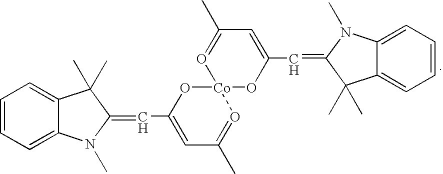

UV/VIS (ethanol): λₘₐₓ=394; ε=64286 l·mol⁻¹·cm⁻¹.

### EXAMPLE 7

9.15 g of 2-aminobenzothiazole are introduced into 100 ml of toluene in a condenser and nitrogen transfer line and the white suspension is heated to an internal temperature of 80° C. Over a period of 30 minutes, 8.45 g of dimethyl sulfate are added dropwise to the clear beige solution, and the thick white suspension is stirred at the same temperature for 1 hour. The suspension is then cooled to 23° C. and filtered, and the residue is washed with 50 ml of toluene in portions. The filter cake is dissolved in 60 ml of water; 13 ml of saturated potassium hydroxide solution are then added and the suspension that forms is stirred at 23° C. for 18 hours. The suspension is then filtered, washed with 75 ml of water In portions and dried at 50° C./2.5·10³ Pa for 18 hours. There are obtained 8.74 g of 3-methyl-3.H.-benzothiazol-2-ylideneamine in the form of white crystals.

### EXAMPLE 8

2.00 g of 3-methyl-3.H.-benzothiazol-2-ylideneamine according to Example 7 and 1.59 g of ethyl acetoacetate are introduced into a 25 ml multi-necked flask equipped with a magnetic stirrer, thermometer, reflux condenser and nitrogen transfer line and stirred at reflux for 45 minutes. The clear solution is then cooled to 23° C., the reaction mixture solidifying. The product is then purified by means of flash chromatography using hexane/ethyl acetate 1:1 as eluant. There are obtained 0.75 g of white crystals of N-(3-methyl-3.H.-benzothiazol-2-ylidene)-3-oxo-butyramide:

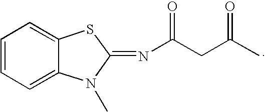

UV/VIS (CH₂Cl₂): λₘₐₓ=317 nm, ε=18040 l·mol⁻¹·cm⁻¹.

### EXAMPLE 9

19.7 g of 2-methylbenzothiazole are introduced into a 350 ml multi-necked vessel equipped with an anchor stirrer, thermometer, dropping funnel, reflux condenser and nitrogen transfer line and heated to an internal temperature of 125° C. 22.38 g of diethyl sulfate are then added dropwise over a period of 20 minutes and the viscous solution is stirred at the same temperature for 2 hours. Cooling to 23° C. is then carried out and the salt that is formed is dissolved in 150 ml of pyridine. The dark-violet solution is cooled to 2° C. using an ice bath and, over a period of 30 minutes, 19.3 g of acetyl chloride are added dropwise using a syringe. The mixture [symbol] Internal temperature of 100° C. for 10 minutes using an oil bath. The brown reaction mixture is then cooled to 23° C. and the solvent is distilled off at 40° C./2.5·10³ Pa. The black resin is then dissolved in 500 ml of water and 500 ml of ethyl acetate and the aqueous phase is extracted twice using 250 ml of ethyl acetate each time. The combined organic phases are washed with 500 ml of water and then with 200 ml of saturated sodium chloride solution, dried over magnesium sulfate and filtered, and the solvent is distilled off at 40° C./2.5·10³ Pa. There are obtained 20.3 g of a red-brown oil, which is refluxed with 700 ml of heptane. The solution is decanted off from the undissolved material, is again heated at reflux and then slowly cooled to 0° C. The crystallised product is filtered off, washed with 300 ml of ice-cold heptane in portions and dried at 40° C./2.5·10³ Pa for 18 hours. There are obtained 10.07 g of slightly yellow crystals of 1-(3-ethyl-3.H.-benzothiazol-2-ylidene)-propan-2-one:

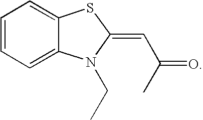

UV/VIS (NMP): λₘₐₓ=354 nm, ε=39100 l·mol⁻¹·cm⁻¹.

### EXAMPLE 10

In a heat-dried 500 ml multi-necked flask equipped with a magnetic stirrer, thermometer, dropping funnel and nitrogen transfer line, 13.68 mmol of lithium diisopropylamide are prepared in 100 ml of abs. THF by a method known per se. The solution is cooled to −70° C. and 80 ml of abs. diethyl ether are added and then, over a period of 1 hour, a solution of 3.0 g of 1-(3-ethyl-3.H.-benzothiazol-2-ylidene)-propan-2-one according to Example 9 in 35 ml of abs. THF and 20 ml of abs. diethyl ether is added dropwise. The resulting orange solution is stirred at −70° C. for 1 hour and then, over a period of 1.5 hours, a solution of 1.07 ml of ethyl isocyanate in 14 ml of diethyl ether is added dropwise at −70° C. Stirring is then carried out for 30 minutes and the solution is then warmed to 0° C. over a period of 15 minutes. The clear orange solution is hydrolysed with 70 ml of saturated aqueous ammonium chloride solution and extracted twice with 100 ml of ethyl acetate. The combined organic phases are washed twice with 140 ml of saturated ammonium chloride solution and once with 100 ml of saturated aqueous sodium chloride solution, dried over magnesium sulfate 4.32 g of an orange resin, which is purified by means of flash chromatography using ethyl acetate as eluant, in the course of which the di-addition product 1,3-diethyl-1-[4-(3-ethyl-3.H.-benzothiazol-2-ylidene)-3-oxo-butyryl]-urea (1.29 g) is eluted. The desired product is then eluted using ethanol. There are obtained 1.42 g of slightly yellow crystals of .N.-ethyl-4-(3-ethyl-3.H.-benzothiazol-2-ylidene)-3-oxo-butyramide:

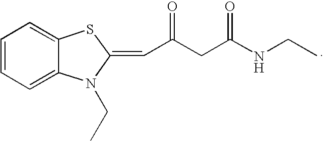

UV/VIS (NMP): λₘₐₓ=359 nm, ε=39800 l·mol⁻¹·cm⁻¹.

### EXAMPLE 11

A mixture of 15.6 g of N,N′-dimethylbarbituric acid, 50 ml of acetic anhydride and 1.5 g of concentrated sulfuric acid is heated at 100° C. for 2 hours. After cooling to 23° C., the start of crystallisation is assisted using methods known per se and the mixture is then allowed to stand for 18 hours. The product precipitated out is filtered off under suction, washed twice using 50 ml of hexane each time and dried at 40° C./2.5·10³ Pa. There are obtained 10.2 g of colourless crystals of 5-acetyl-1,3-dimethyl-pyrimidine-2,4,6-trione:

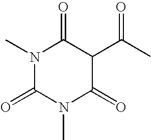

### EXAMPLE 12

1.48 g of N,N-dimethylformamide dimethyl acetal are added to a suspension of 1.98 g of 5-acetyl-1,3-dimethyl-pyrimidine-2,4,6-trione according to Example 11 in 40 ml of tert-butyl methyl ether and stirring is carried out at 23° C. for 16 hours. The solid formed is filtered off under suction and washed twice using 10 ml of diethyl ether each time. The crude product is recrystallised from 60 ml of hot ethanol, filtered off after crystallisation is complete, washed twice using 10 ml of ethanol each time and dried at 40° C./2.5·10³ Pa. There are obtained 1.87 g of light-yellow needles of 5-(3-dimethylamino-1-hydroxy-allylidene)-1,3-dimethyl-pyrimidine-2,4,6-trione:

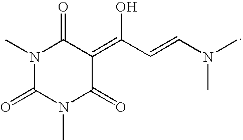

UV/VIS (CH₂Cl₂): λₘₐₓ=377 nm; ε=64515 l·mol⁻¹·cm⁻¹.

### EXAMPLE 13

1.89 g of N-methyl-2-pyrrolidone dimethyl acetal are added to a suspension of 1.98 g of 5-acetyl-1,3-dimethyl-pyrimidine-2,4,6-trione according to Example 11 in 40 ml of tert-butyl methyl ether and stirring is carried out at 23° C. for 16 hours. The suspension is allowed to settle and the liquid phase is decanted off. The residue is stirred with 40 ml of ethanol, and the solid is filtered off, washed with ethanol and dried at 40° C./2.5·10³ Pa. There Is obtained 0.92 g of slightly green-yellow crystals of 5-[1-hydroxy-2-(1-methyl-pyrrolidin-2-ylidene)-ethylidene]-1,3-dimethyl-pyrimidine-2,4,6-trione:

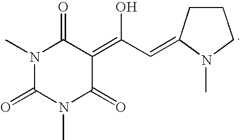

UV/VIS (CH₂Cl₂): λₘₐₓ=371 nm; ε=₆₉₁₉₂ l·mol⁻¹·cm⁻¹.

### EXAMPLE 14

A mixture of 11 g of N,N′-diethylthiobarbituric acid, 30 ml of acetic anhydride and 540 mg of sulfuric acid is heated at 100° C. for 15 minutes. 18 ml of ethanol are slowly added dropwise, with ice cooling, and stirring is then carried out at 23° C. for 10 minutes. The mixture is dried over sodium sulfate and filtered, and the solvent is evaporated off at 40° C./2.5·10³ Pa. The product is re-dissolved in 60 ml of toluene, dried over sodium sulfate and filtered, and the solvent is evaporated off again at 40° C./2.5·10³ Pa and the product is freed of residues of toluene at 25° C./20 Pa. There are obtained 11.4 g of light-yellow solid 5-acetyl-1,3-diethyl-2-thioxo-dihydro-pyrimidine-4,6dione:

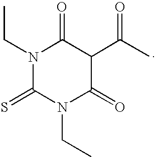

### EXAMPLE 15

0.7 ml of N,N-dimethylformamide dimethyl acetal is added to a solution of 970 mg of 5-acetyl-1,3-diethyl-2-thioxo-dihydro-pyrimidine-4,6-dione according to Example 14 in 10 ml of tert-butyl methyl ether and stirring is carried out at 23° C. for 16 hours. The resulting solid is filtered off, washed with tert-butyl methyl ether and dried at 40° C./2.5·10³ Pa. There are obtained 1.1 g of light-yellow crystals of 5-(3-dimethylamino-1-hydroxy-allylidene)-1,3-diethyl-2-thioxo-dihydro-pyrimidine-4,6-dione:

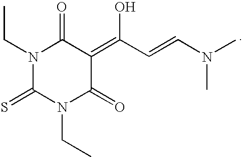

UV/VIS (CH₂Cl₂): λₘₐₓ=399 nm; ε=69795 l·mol⁻¹·cm⁻¹.

### EXAMPLE 16

4.32 g of Meldrum's acid are dissolved in 60 ml of dichloromethane, and 4.4 g of pyridine are added at 0° C. Stirring is carried out for 10 minutes and then 2.36 g of acetyl chloride are slowly added dropwise. Stirring is continued for a further 1 hour at 0° C. and for 16 hours at 23° C. The reaction mixture is washed three times using 50 ml of 10% aqueous citric acid each time, the organic phase is dried over sodium sulfate and filtered, and the solvent is evaporated off at 40° C./2.5·10³ Pa. There are obtained 4.87 g of yellow solid 5-acetyl-2,2-dimethyl-1,3-dioxinane-4,6-dione:

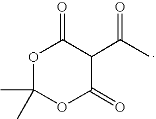

### EXAMPLE 17

1.43 g of dimethylformamide dimethyl acetal are added to a suspension of 1.86 g of 5-acetyl-2,2-dimethyl-1,3-dioxinane-4,6-dione according to Example 16 in 30 ml of tert-butyl methyl ether, and the mixture is stirred at 23° C. for 6 hours and then allowed to stand in a refrigerator for a further 60 hours. The solid formed is filtered off under suction and washed twice using 10 ml of tert-butyl methyl ether each time. The crude product is purified by column chromatography on silica gel using ethyl acetate:heptane (4:1). There are obtained 1.34 g of light-yellow solid 5-(3-dimethylamino-1-hydroxy-allylidene)-2,2-dimethyl-1,3-dioxinane-4,6-dione:

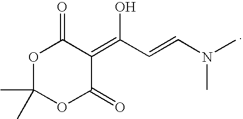

UV/VIS (CH₂Cl₂): λₘₐₓ=363; ε=65311 l·mol⁻¹·cm⁻¹.

### EXAMPLE 18

A mixture of 3.09 g of dimedone, 4 g of acetic acid and 11 g of polyphosphoric acid is heated at 100° C. for 4 hours. After cooling to 23° C., 40 g of ice and 40 ml of water are added and the rubbery product formed is worked with a glass rod until crystallisation is initiated. The solid is filtered off, washed twice using 30 ml of water each time and dried at 40° C./2.5·10³ Pa. There are obtained 2.51 g of light-yellow solid 2-acetyl-5,5-dimethyl-cyclohexane-1,3-dione:

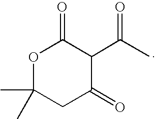

### EXAMPLE 19

1.92 g of dimethylformamide dimethyl acetal are added to a solution of 2.34 g of 2-acetyl-5,5-dimethyl-cyclohexane-1,3-dione according to Example 18 in 26 ml of tert-butyl methyl ether and stirred at 23° C. for 16 hours. The solid formed is filtered off under suction, washed twice using 5 ml of tert-butyl methyl ether each time and dried at 40° C./2.5·10³ Pa. There are obtained 1.44 g of light-yellow powdery 2-(3-dimethylamino-1-hydroxy-allylidene)-5,5-dimethyl-cyclohexane-1,3-dione:

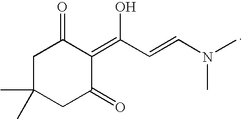

### EXAMPLE 20

474 mg of 2-(3-dimethylamino-acryloyl)-5,5-dimethyl-cyclohexane-1,3-dione according to Example 19 are dissolved in 5 ml of ethanol and stirred at 23° C. with 108 mg of sodium methanolate for 15 minutes. A solution of 134 mg of anhydrous copper(II) chloride in 1.5 ml of ethanol is added and stirring is continued at 23° C. for a further 1½ hour. The reaction solution is diluted with 30 ml of dichloromethane and washed with 10 ml of water. The organic phase is dried over sodium sulfate and filtered and the solvent is removed at 40° C./2.5·10³ Pa. There are obtained 495 mg of green-brown solid bis(2-(3-dimethylamino-acryloyl)-5,5-dimethylcyclohexane-1,3-dionato)copper(II):

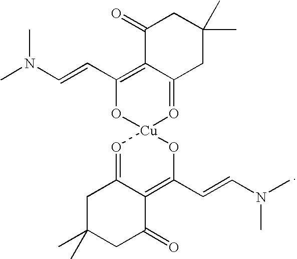

UV/VIS (ethanol): λₘₐₓ=370; ε=75290 l·mol⁻¹·cm⁻¹.

### EXAMPLE 21

472 mg of 2-(3-dimethylamino-acryloyl)-5,5-dimethyl-cyclohexane-1,3-dione according to Example 19 are dissolved in 10 ml of ethanol and stirred at 23° C. with 2 ml of 1N sodium hydroxide solution for 15 minutes. A solution of 237 mg of cobalt(II) chloride hexahydrate in 3 ml of ethanol is added and stirring is continued at 23° C. for a further 18 hours. The solvent is removed at 40° C./2.5·10³ Pa and the residue is taken up in 10 ml of dichloromethane; drying over sodium sulfate and filtration are carried out and the solvent is again removed at 40° C./2.5·10³ Pa. There are obtained 580 mg of bis(2-(3-dimethylamino-acryloyl)-5,5-dimethyl-cyclohexane-1,3-dionato)cobalt(II) in the form of a dark-green solid:

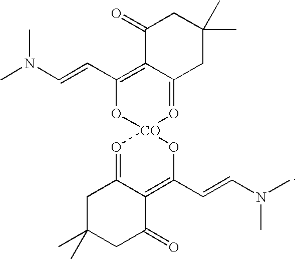

UV/VIS (ethanol): λₘₐₓ=371; ε=60840 l·mol⁻¹·cm⁻¹.

### EXAMPLE 22

474 mg of 2-(3-dimethylamino-acryloyl)-5,5-dimethyl-cyclohexane-1,3-dione according to Example 19 are dissolved in 5 ml of ethanol and stirred at 23° C. with 108 mg of sodium methanolate for 15 minutes. A solution of 129 mg of anhydrous nickel(II) chloride in 1 ml of water is added and stirring Is continued at 23° C. for a further 2 hours. The solvent is removed at 40° C./2.5·10³ Pa and the residue is taken up in 10 ml of dichloromethane; drying over sodium sulfate and filtration are carried out and the solvent is again removed at 40° C./2.5·10³ Pa. There are obtained 463 mg of green solid bis(2-(3-dimethylamino-acryloyl)-5,5-dimethylcyclohexane-1,3-dionato)nickel(II):

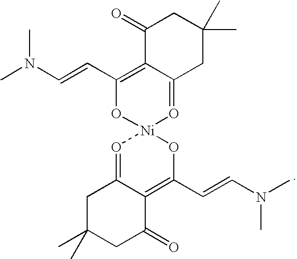

UV/VIS (ethanol): λₘₐₓ373; ε=69450 l·mol⁻¹·cm⁻¹.

### EXAMPLE 23

A mixture of 1.0 g of 3-acetyl-6-methyl-pyran-2,4-dione, 100 mg of palladium-on-carbon (5%) and 15 ml of acetic acid are hydrogenated at 23° C. under a hydrogen pressure of 10 bar for 24 hours. The catalyst is filtered off, washed well with tert-butyl methyl ether and the solution is concentrated to [symbol] by evaporation.

There are obtained 900 mg of colourless solid 3-acetyl-6-methyl-dihydro-pyran-2,4-dione:

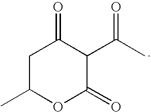

### EXAMPLE 24

480 mg of dimethylformamide dimethyl acetal are added to a suspension of 600 mg of 3-acetyl-6-methyl-dihydro-pyran-2,4-dione according to Example 23 In 7 ml of tert-butyl methyl ether and then stirred at 23° C. for 4 hours and allowed to stand at 23° C. for a further 60 hours. The solid formed Is filtered off under suction, washed twice using 1 ml of tert-butyl methyl ether each time and dried at 40° C./2.5·10³ Pa. There are obtained 542 mg of 3-(3-dimethylamino-1-hydroxy-allylidene)-6-methyl-dihydro-pyran-2,4-dione in the form of a beige powder:

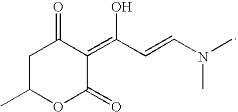

UV/VIS (ethanol): λₘₐₓ=368; ε=59850 l·mol⁻¹·cm⁻¹.

### EXAMPLE 25

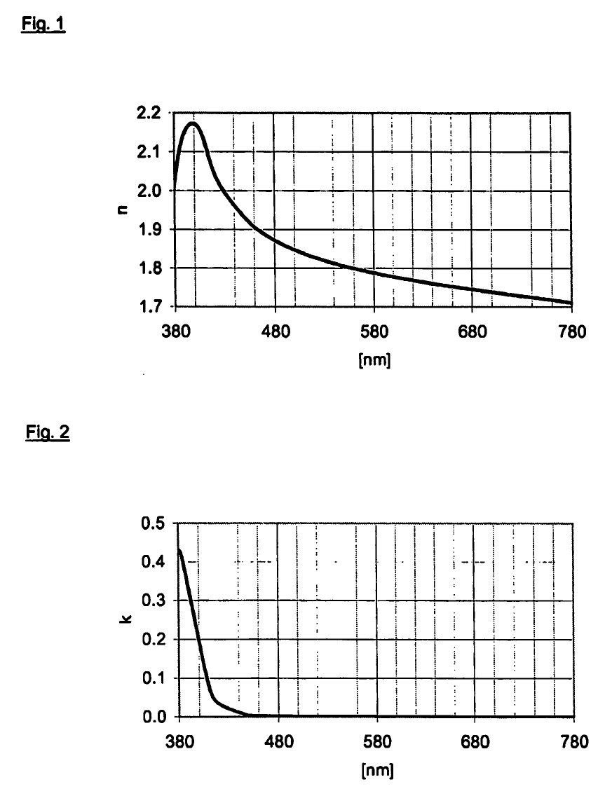

1.0 g of the compound according to Example 2 is dissolved in 99 g of 2,2,3,3-tetrafluoro-1-propanol and filtered through a 0.2 μm Teflon filter. The dye solution is then applied to a 1.2 mm thick, planar polycarbonate plate (diameter 120 mm) by means of spin-coating at 200 rev/min. The excess solution is spun off at 1000 rev/min and a uniform solid layer is formed. After drying, the solid layer has an absorption of 0.63 at 360 nm. Using an optical measuring system (ETA-RT™, STEAG ETAOptik), the layer thickness is found to be 36.7 nm and, at 405 nm, the refractive index n is found to be 2.16 and the extinction coefficient k is found to be 0.137. FIG. 1 shows the refractive index n as a function of wavelength. FIG. 2 shows the extinction coefficient k as a function of wavelength.

### EXAMPLE 26

In a vacuum-coating apparatus (Twister™, Balzers Unaxis), a 50 nm thick reflector layer of silver is applied to a 1.1 mm thick, grooved polycarbonate disc 1.0% by weight of the compound according to Example 2 is dissolved In 2,2,3,3-tetrafluoro-1-propanol and filtered through a 0.2 μm Teflon filter. The dye solution is then applied over the reflector layer by the spin-coating method at 250 rev/min. The excess solution is spun off at 1800 rev/min and a uniform solid layer is obtained. After drying (20 minutes/70° C.), the solid layer has an absorption of 0.48 at 360 nm. A UV-crosslinkable photopolymer (SD-347™, Dainippon Ink) is then applied by spin-coating in a thickness of about 10 μm and is crosslinked with UV light. Using a GaN laser diode (Nichia) of wavelength 404 nm, marks are written into the active layer at an output of 5.5 mW and a linear speed of 5 m/s. This operation results in a substantial reduction In reflectivity at the irradiated sites.

### EXAMPLES 27-42

The compounds according to Examples 1, 3, 4, 5, 8, 6, 10, 12, 13, 15, 17, 19, 20, 21, 22 and 24 are used analogously to Example 26.

1. An optical recording medium comprising a substrate, a recording layer and optionally a reflecting layer, wherein the recording layer comprises a compound of formula 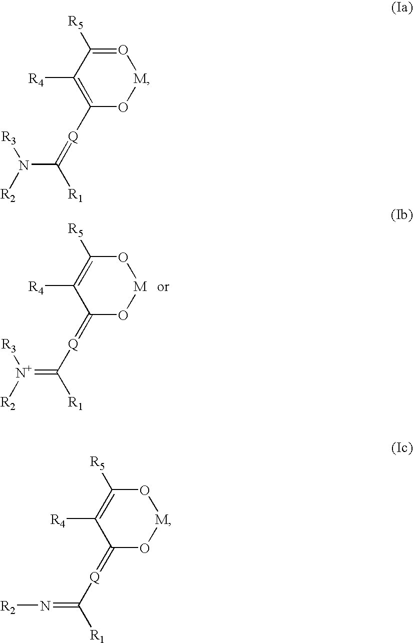
wherein
M is hydrogen, aluminium or a transition metal, which may in addition be coordinated with one or more further ligands and/or, for balancing out an excess charge, where applicable, may have an electrostatic interaction with one or more further ions inside or outside the coordination sphere, but M in formulae (Ib) and (Ic) is not hydrogen,
Q is C—H, N or C—R₆, it being possible for the stereochemistry of the C=Q double bond to be either E or Z,
R₁ is hydrogen, OR₇, SR₇, NHR₇, NR₇R₈, C₁-C₁₂alkyl, C₂-C₁₂alkenyl, C₂-C₁₂alkynyl, C₃-C₁₂cycloalkyl, C₃-C₁₂cycloalkenyl, C₇-C₁₂aralkyl, C₂-C₂-C₁₁heteroaralkyl, C₆-C₁₀aryl or C₁-C₉heteroaryl,
R₂ and R₃ are each independently of the other C₁-C₁₂alkyl, C₂-C₁₂alkenyl, C₂-C₁₂alkynyl, C₃-C₁₂cycloalkyl, C₃-C₁₂cycloalkenyl, C₇-C₁₂aralkyl, C₂-C₁₁heteroaralkyl, C₆-C₁₀aryl or C₁-C₉heteroaryl,
R₄ is cyano, COR₉, COOR₇, CONH₂, CONHR₇, CONR₇R₈, C₂-C₁₂alk-1-enyl, C₃-C₁₂cycloalk-1-enyl, C₂-C₁₂alk-1-ynyl, C₂-C₅heterocycloalkyl, C₃-C₅heterocycloalkenyl, C₆-C₁₀aryl or C₁-C₉heteroaryl,
R₅ is cyano, COR₇, COOR₇, CONH₂, CONHR₇, CONR₇R₈, NHR₉, NR₈R₉, C₁-C₁₂alkyl, C₂-C₁₂alkenyl, C₂-C₁₂alkynyl, C₃-C₁₂cycloalkyl, C₃-C₁₂cycloalkenyl, C₇-C₁₂aralkyl, C₂-C₁₁heteroaralkyl, C₆-C₁₀aryl or C₁-C₉heteroaryl,
R₆, R₇ and R₈ are each independently of the others C₁-C₁₂alkyl, C₂-C₁₂alkenyl, C₂-C₁₂alkynyl, C₃-C₁₂cycloalkyl, C₃-C₁₂cycloalkenyl, C₇-C₁₂aralkyl, C₂-C₁₁heteroaralkyl, C₆-C₁₀aryl or C₁-C₉heteroaryl, it being possible for R₁ and R₂, R₁ and R₆, R₂ and R₃, R₂ and R₇, R₃ and R₆, R₄ and R₅, R₄ and R₆, R₄ and R₇ and/or R₇ and R₈ in pairs to be so linked to one another that 1, 2, 3 or 4 carbocyclic or N-, O- and/or S-heterocyclic rings are formed, it being possible for any such ring, independently of any other(s), where applicable to be fused to an aromatic or heteroaromatic ring and/or for a plurality of N-, O- and/or S-heterocyclic rings to be fused to one another, and
it being possible for any N in an N-heterocyclic ring to be unsubstituted or substituted by R₉; it being possible for any alkyl, alkenyl, alkynyl (in each case, where applicable, as part of non-aromatic rings), cycloalkyl or cycloalkenyl and, where applicable, a plurality of alkyl, alkenyl, alkynyl, cycloalkyl and/or cycloalkenyl groups independently of one another to be unsubstituted or mono- or poly-substituted by R₁₀;
and it being possible for any aryl, heteroaryl or aralkyl or, where applicable, a plurality of aryl, heteroaryl and/or aralkyl groups independently of one another to be unsubstituted or mono- or poly-substituted by R₁₁;
R₉ is H, R₇, COR₇, COOR₇, CONH₂, CONHR₇ or CONR₇R₈;
R₁₀ is halogen, OH, NH₂, NHR₁₂, NR₁₂R₁₃, NHNH₂, NHNHR₁₂, NHNR₁₂R₁₃, NR₁₄NH₂, NR₁₄NHR₁₂, NR₁₄NR₁₂R₁₃, NHOH, NHOR₁₂, NR₁₄OH, NR₁₄OR₁₂, O—R₁₂, O—CO—R₁₂, S—R₁₂, CO—R₁₂, oxo, thiono, ═N—R₁₂, ═N—OH, ═N—O*, ═N—OR₁₂, ═N—NH₂, ═N—NHR₁₂, ═N—NR₁₂R₁₃, CN, COOH, CONH₂, COOR₁₂, CONHR₁₂, CONR₁₂R₁₃, SO₂NH₂, SO₂NHR₁₂, SO₂NR₁₂R₁₃, SO₂R₁₂, SO₃R₁₂ or PO(OR₁₂)(OR₁₃);
R₁₁ is halogen, NO₂, CN, NH₂, SH, OH, CHO, R₁₅, OR₁₅, SR₁₅, C(R₁₆)═CR₁₇R₁₈, O—CO—R₁₉, NHR₁₉, NR₁₉R₂₀, CONH₂, CONHR₁₉, CONR₁₉R₂₀, SO₂NH₂, SO₂NHR₁₉, SO₂NR₁₉R₂₀, SO₂R₁₉, COOH, COOR₁₉, OCOOR₁₉, NHCOR₁₉, NR₁₉COR₂₁, NHCOOR₁₉, NR₁₉COOR₂₁, P(═O)OR₁₉OR₂₁, P(═O)R₁₉OR₂₁, P(═O)R₁₉R₂₁, or being C₁-C₁₂alkyl, C₃-C₁₂cycloalkyl, C₂-C₁₂alkenyl, C₃-C₁₂cycloalkenyl, C₁-C₁₂alkylthio, C₃-C₁₂cycloalkylthio, C₂-C₁₂alkenylthio, C₃-C₁₂cycloalkenylthio, C₁-C₁₂alkoxy, C₃-C₁₂cycloalkoxy, C₂-C₁₂alkenyloxy or C₃-C₁₂cycloalkenyloxy each unsubstituted or substituted by one or more, where applicable identical or different, R₁₀ radicals;
R₁₂, R₁₃ and R₁₄ are each independently of the others C₁-C₁₂alkyl, C₃-C₁₂cycloalkyl, C₂-C₁₂alkenyl, C₃-C₁₂cycloalkenyl, C₆-C₁₄aryl, C₁-C₁₂heteroaryl, C₇-C₁₈aralkyl or C₂-C₁₆heteroaralkyl; or
R₁₂ and R₁₃, together with the common N, are pyrrolidine, piperidine, piperazine or morpholine each unsubstituted or mono- to tetra-substituted by C₁-C₄alkyl;
R₁₅ is C₆-C₁₄aryl, C₁-C₁₂heteroaryl, C₇-C₁₈aralkyl or C₂-C₁₆heteroaralkyl each unsubstituted or substituted by one or more, where applicable identical or different, R₂₂ radicals;
R₁₆ is hydrogen, cyano, halogen, nitro, or being C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals, or being C₆-C₁₄aryl, C₁-C₁₂heteroaryl, C₇-C₁₈aralkyl or C₂-C₁₆heteroaralkyl each unsubstituted or substituted by one or more, where applicable identical or different, R₁₀ and/or nitro radicals;
R₁₇ and R₁₈ is each independently of the other NR₁₉R₂₀, CN, CONH₂, CONHR₁₉, CONR₁₉R₂₀ or COOR₂₀;
R₁₉, R₂₀ and R₂₁ be are each independently of the others R₁₅, or being C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals; or
R₁₉ and R₂₀, together with the common N, pyrrolidine, piperidine, piperazine or morpholine each unsubstituted or mono- to tetra-substituted by C₁-C₄alkyl; or being carbazole, phenoxazine or phenothiazine each unsubstituted or substituted by one or more, where applicable identical or different, R₂₂ radicals; and
R₂₂ is halogen, NO₂, SO₂NH₂, SO₂NHR₁₂, SO₂NR₁₂R₁₃, or being C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each substituted by one or more, where applicable identical or different, R₁₀ radicals; wherein
when R₇, R₈, R₉, R₁₀, R₁₁, R₁₂, R₁₃, R₁₄, R₁₅, R₁₆, R₁₇, R₁₈, R₁₉, R₂₀, R₂₁ and/or R₂₂ are present more than once, each of them is independent of all others; and/or
two identical or different entities of formula (Ia), (Ib) or (Ic) may have a common partial structure or be joined by a direct bond; and, when M in two such joined entities is the same, it may also be a single atom.

2. An optical recording medium according to claim 1, wherein M is Al, Au, Bi, Cd, Ce, Co, Cu, Cr, Hf, In, Ir, Mn, Mo, Nb, Ni, Fe, Os, Pb, Pd, Pt, Re, Rh, Ru, Si, Sn, Ta, Ti, V, W, Zn or Zr).

3. An optical recording medium according to claim 1, wherein, when R₁ and R₆ together and/or R₄ and R₅ together form a carbocyclic or heterocyclic ring, that ring is neither an aromatic ring nor a pyrone.

4. An optical recording medium according to claim 3, wherein a carbocyclic or heterocyclic ring which may be formed by R₁ and R₆ and/or by R₄ and R₅ has at least one fully saturated carbon in the ring.

5. An optical recording medium according to claim 1, wherein Q is C—H or N, R₉ is R₇, and/or where applicable a carbocyclic or N-, O- and/or S-heterocyclic non-aromatic ring having from 3 to 12 members.

6. An optical recording medium according to claim 1 wherein R₄ and R₅ together form a 5- or 6-membered ring.

7. An optical recording medium according to claim 1 wherein the recording layer comprises a compound of formula 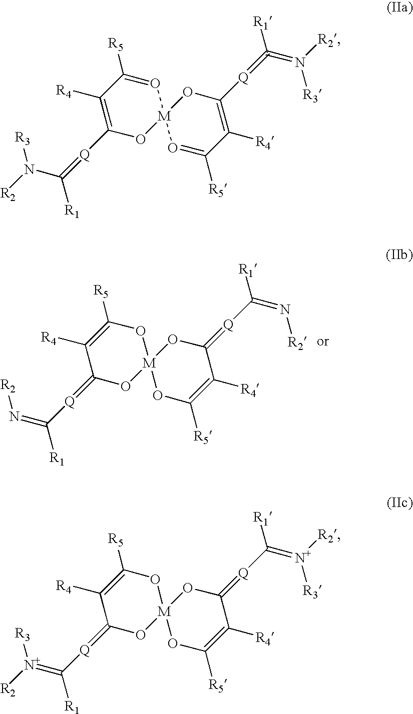
(IIc), or a stereoisomer, oligomer or tautomer thereof,
wherein M is aluminium or a transition metal and R₁′ independently of R₁ is as defined for R₁, R₂′ independently of R₂ is as defined for R₂, R₃′ independently of R₃ is as defined for R₃, R₄′ independently of R₄ is as defined for R₄, and R₅′ independently of R₅ is as defined for R₅, it being possible for R₁′ and R₁, for R₂′ and R₂, for R₃′ and R₃, for R₄′ and R₄, and for R₅′ and R₅ in each case to be identical or different and it being possible, where appropriate, for a radical R₁′, R₂′, R₃′, R₄′ or R₅′ to be bonded to a radical R₁, R₂, R₃, R₄ or R₅ by a direct bond.

8. An optical recording medium according to claim 1, wherein the recording layer comprises at least two compounds of formula (Ia), (Ib) or (Ic), at least two compounds of formula (IIa), (IIb) or (IIc), or at least one compound of formula (Ia), (Ib), (Ic), (IIa), (IIb) or (IIc) wherein M is aluminium or a transition metal together with a compound of formula (Ia) wherein M is hydrogen.

9. A method of recording or playing back data, wherein the data on an optical recording medium according to claim 1, are recorded or played back at a wavelength of from 300 to 500 nm.

10. A compound of formula (Ia), (Ib) or (Ic) according to claim 1, wherein M is a transition metal, with the proviso that, when R₁ and R₆ together and/or R₄ and R₅ together form a carbocyclic or heterocyclic ring, that carbocyclic or heterocyclic ring is neither an aromatic ring nor a pyrone.

11. A chelate of formula 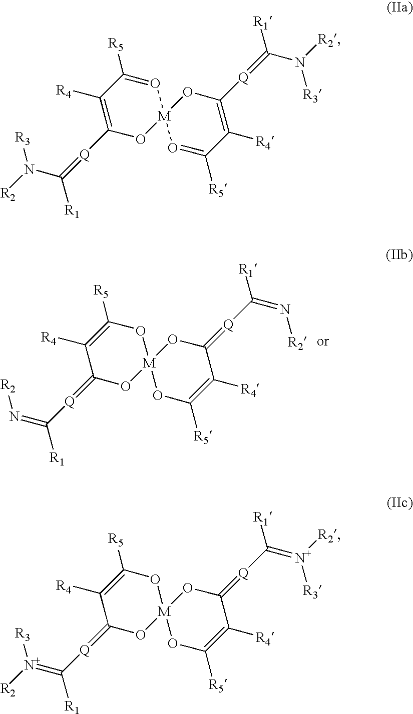
or a stereoisomer, oligomer or tautomer thereof,
wherein M is aluminium or a transition metal and R₁′ independently of R₁ is as defined for R₁, R₂′ independently of R₂ is as defined for R₂, R₃′ independently of R₃ is as defined for R₃, R₄′ independently of R₄ is as defined for R₄, and R₅′ independently of R₅ is as defined for R₅, it being possible for R₁′ and R₁, for R₂′ and R₂, for R₃′ and R₃, for R₄′ and R₄, and for R₅′ and R₅ in each case to be identical or different and it being possible, where appropriate, for a radical R₁′, R₂′, R₃′, R₄′ or R₅′ to be bonded to a radical R₁, R₂, R₃, R₄ or R₅ by a direct bond, and Q, R₁, R₂, R₃, R₄ and R₅ being as defined in claim 1.

12. A process for the preparation of a chelate of formula (IIa), (IIb) or (IIc) according to claim 11, which comprises
(a) deprotonating a compound of formula (Ia), (Ib) or (Ic) according to claim 1, 2, 5 or 6 or a compound of formula (IIa) according to claim 7, wherein M is hydrogen, in a hydrophilic, O-containing liquid using a base;
(b) adding a non-inert salt of aluminium or a transition metal M;
(c) optionally adding additional ligands in a from 1.0× to 1.5× stoichiometric amount;
(d) optionally adding another liquid which is miscible with the O-containing liquid so that the chelate of formula (IIa), (IIb) or (IIc) precipitates out; and
(e) isolating the chelate of formula (IIa), (IIb) or (IIc).

13. (canceled)

14. An optical recording medium according to claim 1, wherein M is a transition metal.

15. An optical recording medium according to claim 2, wherein M is Co, Cu or Ni.
